(19) United States
(12) Patent Application Publication
(10) Pub. No.: US 2026/0227070 A1
(43) Pub. Date: Aug. 6, 2026

(54) METHOD OF OPERATING A ROTATING DETONATION COMBUSTOR

(71) Applicant: General Electric Company, Evendale, OH (US)

(72) Inventors: Arin Elspeth Lastufka Cross, Waterford, NY (US); Sarah M. Monahan, Latham, NY (US); Daniel Depperschmidt, Saratoga Springs, NY (US); Kapil Singh, Rexford, NY (US); Hannah Erin Bower, Rexford, NY (US); Aaron J. Glaser, Cincinnati, OH (US); Eric J. Ruggiero, West Chester, OH (US)

(21) Appl. No.: 19/046,665

(22) Filed: Feb. 6, 2025

(51) Int. Cl. F23R 7/00; F02C 7/22; F02K 7/10

(52) U.S. Cl. CPC F23R 7/00; F02C 7/22; F02K 7/10; F05D 2240/35

(57) ABSTRACT

A method of operating a rotating detonation combustor includes providing a flow of air through an air inlet into a detonation chamber, providing fuel from a fuel injector into one of the air inlet or the detonation chamber, mixing the fuel and air to generate a fuel-air mixture, detonating the fuel-air mixture to generate rotating detonation waves, and controlling, during operation of the rotating detonation combustor from a first power operating state to a second power operating state, different from the first power operating state, a flow of an auxiliary gas through an auxiliary gas injection port into one of the air inlet to mix with the flow of the air within the air inlet to control a discharge coefficient of the air inlet, or into the detonation chamber to control a discharge coefficient of the detonation chamber, and to control an operating mode of the rotating detonation combustor.

### TECHNICAL FIELD

The present disclosure relates generally to a method of operating a rotating detonation combustor.

### BACKGROUND

Aircraft engines generally include a combustor in which a mixture of air and fuel is ignited and burned. Rotating detonation combustors (RDCs) have been proposed as a means of increasing the performance and efficiency of such engines. In an RDC, an air and fuel mixture is detonated to generate a rotating detonation wave that forms a resulting exhaust mixture. The rotating detonation wave traverses around a detonation chamber such that the detonation wave revolves around a combustion chamber centerline axis. The resulting exhaust mixture also travels axially through the detonation chamber to an outlet of the detonation chamber.

### BRIEF DESCRIPTION OF THE DRAWINGS

Features and advantages will be apparent from the following, more particular, description of various exemplary embodiments, as illustrated in the accompanying drawings, wherein like reference numbers generally indicate identical, functionally similar, and/or structurally similar elements.

FIG. 1 is a schematic, cross-sectional view of a propulsion or power generation system, according to an aspect of the present disclosure.

FIG. 2 is a cross-sectional view of a rotating detonation combustor, taken at detail view 91 of FIG. 1, according to an aspect of the present disclosure.

FIG. 3 is a cross-sectional view of a portion of the rotating detonation combustor of FIG. 2, taken at detail view 158 in FIG. 2, according to an aspect of the present disclosure.

FIG. 4 is a schematic, perspective view of a detonation chamber and a rotating detonation wave within the detonation chamber, according to an aspect of the present disclosure.

FIG. 5 is a cross-sectional view of an alternate rotating detonation combustor to that shown in FIG. 2, according to an aspect of the present disclosure.

FIG. 6 is a cross-sectional view of a rotating detonation combustor for an augmenter, according to an aspect of the present disclosure.

FIG. 7 is a cross-sectional view of an alternate rotating detonation combustor of the augmenter to that shown in FIG. 6, according to an aspect of the present disclosure.

FIG. 8 is a cross-sectional view of an alternate rotating detonation combustor to that shown in FIG. 2, according to another aspect of the present disclosure.

FIG. 9 is a cross-sectional view of a portion of the rotating detonation combustor of FIG. 8, taken at detail view 242 in FIG. 8, according to an aspect of the present disclosure.

FIG. 10A and FIG. 10B depict a flowchart of process steps for a method of operating an engine having a rotating detonation combustor, according to an aspect of the present disclosure.

FIG. 11 is a cross-sectional view of an alternate rotating detonation combustor to the rotating detonation combustor of FIG. 2, according to an aspect of the present disclosure.

### DETAILED DESCRIPTION

Features, advantages, and embodiments of the present disclosure are set forth or are apparent from a consideration of the following detailed description, drawings, and claims. Moreover, the following detailed description is exemplary and is intended to provide an explanation without limiting the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

As used herein, the terms “first” or “second” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a gas turbine engine or vehicle, and are based on a normal operational attitude of the gas turbine engine or vehicle. More particularly, forward and aft are used herein with reference to a direction of travel of the vehicle and a direction of propulsive thrust of the gas turbine engine.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the turbine engine. Moreover, the terms “radial” and “radially” refer to directions and orientations that extend substantially perpendicular to the centerline of the turbine engine. In addition, as used herein, the terms “circumferential” and “circumferentially” refer to directions and orientations that extend arcuately about the centerline of the turbine engine.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

Aircraft engines generally include a combustor in which a mixture of air and fuel is ignited and burned. Some combustors may be arranged as a rotating detonation combustor (RDC) in which the air and fuel mix together and react to generate a rotating detonation wave. The rotating detonation wave traverses around a detonation chamber such that the detonation wave travels around a combustion chamber centerline axis. The resulting exhaust mixture also travels axially through the detonation chamber to an outlet of the detonation chamber. An RDC may support one detonation wave or multiple detonation waves, and the detonation waves may co-rotate about the combustion chamber centerline axis, or may counter-rotate with respect to one another about the combustion chamber centerline axis. The detonation waves may also include dominant detonation waves and secondary detonation waves.

One concern with rotating detonation combustors is the ability to adjust the detonation operating mode, or the number and the type of the detonation waves, within the detonation chamber based on different engine power requirements throughout an engine cycle.

The present disclosure provides a technique to control a discharge coefficient of an air inlet of the RDC, which results in changes to the detonation operating mode by changing an effective flow volume of a fuel-air mixture in a detonation region of the detonation chamber. The discharge coefficient is defined as a ratio of an effective area of the air inlet to a physical geometric area of the air inlet. The effective area is determined from a measured mass flow and flow properties of a fluid (e.g., air or a fuel-air mixture) through the air inlet, and corresponds to the area that a given flow should theoretically require. The mass flow, and thus, the effective area and the coefficient of discharge, may be influenced by factors such as boundary layer thickness, turbulence, viscosity, and geometry features of the air inlet.

In the present disclosure, the air inlet of the rotating detonation combustor has a fixed size and provides a flow of compressed air, or a flow of a gaseous oxidizer, or a fuel-air mixture, into the detonation chamber. In one aspect, fuel is injected into the air inlet to mix with the compressed air to generate the fuel-air mixture that is then injected into the detonation chamber via the air inlet. In another aspect, the fuel and air are injected into the detonation chamber separately to generate the fuel-air mixture within the detonation chamber rather than within the air inlet. For example, the compressed air is injected into the detonation chamber via the air inlet, while the fuel is injected into the detonation chamber via separate fuel injectors. In both aspects, however, a plurality of auxiliary gas injection ports are arranged to inject an auxiliary gas into the air inlet to manipulate the effective area of the air inlet, based on operating cycle requirements. The auxiliary gas injection provides a technique to control the discharge coefficient of the air inlet into the detonation chamber, and to control the operating mode of the rotating detonation combustor to meet various cycle requirements.

The operating mode refers to the number of detonation waves, the orientation of the detonation waves, and the presence, the orientation, or the number of detrimental acoustic waves. The operating mode is determined by the inlet conditions supplied to the system and physics dictating a detonation phenomenon. One parameter of the operating mode is a fill height of the fuel-air mixture within the detonation chamber. The fill height is the radial height, over a given axial fill length, of the reactants (i.e., the fuel-air mixture) within the detonation chamber that occurs after one detonation wave passes before a subsequent detonation wave consumes the reactants. The fill height can be adjusted by increasing the total mass flow of air to the system. The result is that the “effective” volume of the channel is less than the physical volume of the channel. That is, the reactant gases are not occupying the full physical width of the channel. A reduction of the discharge coefficient of the air inlet has a corresponding reduction of the “effective fill volume” within the detonation chamber, since the width of the channel occupied by reactant gases is also reduced. Adjusting the effective fill volume can impact whether detonation waves form and whether they bifurcate into more than one wave. As the detonation waves travel about the detonation chamber, the detonation waves consume the reactants. Ideally, the detonation waves do not consume too many reactants too fast, or too little reactants too slowly, such that the mixture becomes either too lean or too rich to keep the detonation self-sustained. There should be a consistent cycle of consumption of the reactants and a refresh of the reactants within the detonation chamber, and the number of detonation waves may impact the consistency of the cycle.

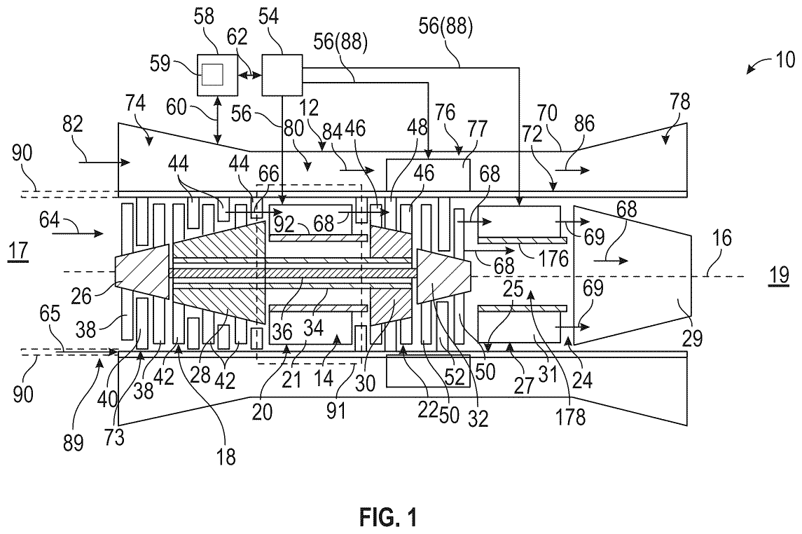

FIG. 1 is a schematic cross-sectional view of a propulsion system 10, according to an aspect of the present disclosure. The propulsion system 10 may be a combined-cycle propulsion system that includes a ramjet engine 12 and a turbo-engine 14, each of which extends about a longitudinal centerline axis 16. The longitudinal centerline axis 16 extends from an upstream end 17 of the propulsion system 10 to a downstream end 19 of the propulsion system 10. While the propulsion system 10 depicted in FIG. 1 includes both the ramjet engine 12 and the turbo-engine 14, the propulsion system 10 may include either the ramjet engine 12 or the turbo-engine 14, and need not include both. The following description, however, will be made with the arrangement of FIG. 1 including both the ramjet engine 12 and the turbo-engine 14. The turbo-engine 14 may be, for example, a turbojet engine that includes, in a serial flow relationship and encased within a turbo-engine outer casing 25 that extends circumferentially about the longitudinal centerline axis 16, a compressor section 18, a turbine engine combustion section 20 (shown generally in FIG. 1), a turbine section 22, and an exhaust section 24 that may include an augmenter 27 and an exhaust nozzle 29. As will be described in more detail below, the turbine engine combustion section 20 may include a rotating detonation combustor (RDC) 21, and the augmenter 27 may also include a rotating detonation combustor 31, each of which may be similar to one another. The compressor section 18 includes a low-pressure compressor (LPC) 26 and a high-pressure compressor (HPC) 28. The turbine section 22 includes a high-pressure turbine (HPT) 30 and a low-pressure turbine (LPT) 32. The HPT 30 and the HPC 28 are drivingly connected together via a high-pressure shaft 34, and the LPT 32 and the LPC 26 are drivingly connected together via a low-pressure shaft 36.

The LPC 26 includes a plurality of low-pressure compressor rotors (not shown individually) that each has a plurality of circumferentially spaced apart low-pressure compressor rotor blades 38 extending radially outward therefrom, and a plurality of circumferentially spaced apart low-pressure compressor stator vanes 40 extending radially inward from the turbo-engine outer casing 25. Similarly, the HPC 28 includes a plurality of high-pressure compressor rotors (not shown individually) that each has a plurality of circumferentially spaced apart high-pressure compressor rotor blades 42 extending radially outward therefrom, and a plurality of circumferentially spaced apart high-pressure compressor stator vanes 44 extending radially inward from the turbo-engine outer casing 25. As will be described below, a volume of air passing through the compressor section 18 is increasingly compressed by the low-pressure compressor rotor blades 38, the low-pressure compressor stator vanes 40, the high-pressure compressor rotor blades 42, and the high-pressure compressor stator vanes 44 before flowing into the turbine engine combustion section 20.

The HPT 30 includes a plurality of high-pressure turbine rotors (not shown individually) that each has a plurality of circumferentially spaced apart high-pressure turbine rotor blades 46 extending radially outward therefrom, and a plurality of circumferentially spaced apart high-pressure turbine stator vanes 48 extending radially inward from the turbo-engine outer casing 25. Similarly, the LPT 32 includes a plurality of low-pressure turbine rotors (not shown individually) that each has a plurality of circumferentially spaced apart low-pressure turbine rotor blades 50 extending radially outward therefrom, and a plurality of circumferentially spaced apart low-pressure turbine stator vanes 52 extending radially inward from the turbo-engine outer casing 25. As will be described below, a volume of combustion gases generated by the turbine engine combustion section 20 and passing through the turbine section 22 is increasingly expanded by the high-pressure turbine rotor blades 46, the high-pressure turbine stator vanes 48, the low-pressure turbine rotor blades 50, and the low-pressure turbine stator vanes 52 before flowing into the exhaust section 24. In addition, as will be described below, work is extracted from the combustion gases by each of the HPT 30 and the LPT 32 so as to cause each of the HPT 30 and the LPT 32 to rotate, thereby supporting operation of the HPC 28 and the LPC 26, respectively.

The turbine engine combustion section 20 will be described in more detail below, but, briefly, the turbine engine combustion section 20 receives a flow of fuel 56 from a fuel supply system 54. The fuel supply system 54, although shown generally in FIG. 1, may include one or more fuel tanks arranged in various locations within an aircraft upon which the propulsion system 10 is mounted, one or more fuel pumps, and one or more fuel supply lines that provide the fuel 56 to the turbine engine combustion section 20. The fuel supply system 54, as well as the propulsion system 10, are controlled by an engine controller 58 that communicates with the propulsion system 10 via a communication channel 60, and that communicates with the fuel supply system 54 via a communication channel 62. The communication channel 60 and the communication channel 62 may be a wired communication channel or a wireless communication channel arranged on the aircraft.

In operation of the turbo-engine 14, a volume of air 64 enters the compressor section 18, and the air 64 is compressed by LPC 26 and the HPC 28 to generate compressed air 66. The compressed air 66 is then provided to the turbine engine combustion section 20 where, as will be described in more detail below, the compressed air 66 is mixed with the fuel 56 and a fuel-air mixture is then ignited (or detonated) and burned to generate combustion gases 68. The combustion gases 68 flow through the turbine section 22 where work or kinetic energy is extracted from the combustion gases 68 to cause each of the HPT 30 and the LPT 32 to rotate, thereby driving and supporting operation of each of the HPC 28 and the LPC 26, respectively. The combustion gases 68 may then flow, at least in part, to the rotating detonation combustor 31 of the augmenter 27, and the remaining combustion gases 68 are exhausted through the exhaust section 24 to provide thrust. As will be described in more detail below, the rotating detonation combustor 31 of the augmenter 27 may utilize, at least in part, the combustion gases 68 and be supplied with either the fuel 56 or the fuel 88 to generate augmenter combustion gases 69, which are exhausted through the exhaust nozzle 29 through which the combustion gases 68 also flow.

The ramjet engine 12 in FIG. 1 is shown to be arranged radially outward of the turbo-engine 14 and extends circumferentially about the longitudinal centerline axis 16. This arrangement, however, is merely one example of the ramjet engine 12. Instead, the ramjet engine 12 may extend only partially annularly about the longitudinal centerline axis 16, or may be arranged as a linear-type ramjet engine that is separate from the turbo-engine 14. Thus, the following description of the ramjet engine 12 is merely exemplary and the present disclosure is not limited to the configuration of the ramjet engine 12 shown in FIG. 1. In the FIG. 1 aspect, the ramjet engine 12 includes a ramjet engine outer casing 70, and a ramjet engine inner casing 72. A ramjet engine cooling passage 73 is arranged between the turbo-engine outer casing 25 and the ramjet engine inner casing 72 to allow a flow of cooling air 65 to flow therethrough and to provide cooling to the ramjet engine inner casing 72. The ramjet engine 12 includes, in a serial flow relationship, a ramjet inlet section 74, a ramjet combustion section 76 (shown generally in FIG. 1), and a ramjet exhaust section 78, each of which is defined between the ramjet engine inner casing 72 and the ramjet engine outer casing 70. As will be described in more detail below, the ramjet combustion section 76 may include an RDC 77 that may be the same as the RDC 21 of the turbine engine combustion section 20. The ramjet inlet section 74 is arranged as a converging section so as to compress a flow of air 82 entering the ramjet inlet section 74. The ramjet inlet section 74 may include an isolator portion 80 that, in a case when supersonic airflow enters the ramjet inlet section 74, organizes shockwaves of the supersonic airflow within the ramjet inlet section 74 so as to provide a sub-sonic airflow from the ramjet inlet section 74 to the ramjet combustion section 76. As will be described below, the ramjet combustion section 76 may be similar to the turbine engine combustion section 20 of the turbo-engine 14, and the ramjet combustion section 76 generates combustion gases 86 that flow into the ramjet exhaust section 78. The ramjet exhaust section 78 may be arranged as a diverging exhaust section so as to expand the combustion gases 86 generated by the ramjet combustion section 76 to provide thrust.

In operation of the ramjet engine 12, a volume of air 82 enters the ramjet inlet section 74. The air 82, as was described above, may enter the ramjet inlet section 74 as a supersonic airflow. The ramjet inlet section 74 compresses the air 82, and, in the case when the air 82 is a supersonic airflow, organizes shockwaves within the isolator portion 80 of the ramjet inlet section 74, and provides compressed air 84 to the ramjet combustion section 76. As will be described below, in the ramjet combustion section 76, the fuel 56, or a different type of fuel 88, is provided by the fuel supply system 54 to the ramjet combustion section 76, and the fuel 56 or the fuel 88 is utilized by the rotating detonation combustor 77 to be mixed with the compressed air 84 to generate a fuel-air mixture that is then ignited (or detonated) within the rotating detonation combustor 77 to generate detonation waves (described below) and to produce the ramjet combustion gases 86. As an example of different fuel types, the fuel 56 may be a hydrocarbon-type fuel, such as Jet A fuel, while the fuel 88 may be a more highly reactive fuel, such as hydrogen. The ramjet combustion gases 86 then flow through the ramjet exhaust section 78, where the ramjet combustion gases 86 are expanded through the ramjet exhaust section 78 to provide thrust.

In the propulsion system 10 of FIG. 1, the turbo-engine 14 may be operated through a particular airspeed of the aircraft upon which the propulsion system 10 is mounted, while the ramjet engine 12 may be operated at higher airspeeds of the aircraft. For example, the turbo-engine 14 may be operated during ground operations up through an aircraft airspeed of about Mach 1.5, while the ramjet engine 12 may be operated for aircraft airspeeds above Mach 1.0. While shown generally in FIG. 1, the turbo-engine 14 may include an inlet airflow regulator system 89 (e.g., movable doors 90) upstream of the compressor section 18 so as to block air 64 from flowing into the turbo-engine 14 during the higher speed operations in which the ramjet engine 12 is operable. That is, the inlet airflow regulator system 89 (e.g., the movable doors 90) may be closed to block the air 64 from entering the compressor section 18 at higher airspeeds, and the engine controller 58 controls the turbo-engine 14 and the fuel supply system 54, so as to stop the flow of the fuel 56 and to stop the operation of the turbo-engine 14. Alternatively, bleed air passages (not shown in FIG. 1) may be provided in the turbo-engine outer casing 25 to provide a flow of the cooling air 65 from the ramjet engine cooling passage 73 to various components of the turbo-engine 14 (e.g., to the compressor section 18, to the RDC 21, or to the rotating detonation combustor 31 of the augmenter 27) during the higher speed operations so as to maintain some minimal level of operation of the turbo-engine 14 during the higher speed operations, even though the inlet airflow regulator system 89 may block the flow of the air 64.

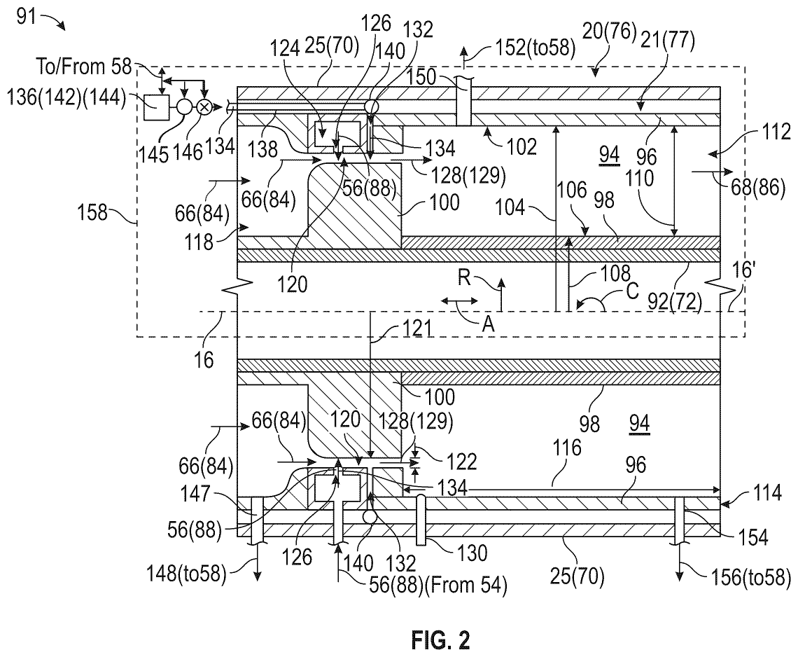

FIG. 2 is a cross-sectional view of the RDC 21 (and RDC 77), taken at detail view 91 of FIG. 1, according to an aspect of the present disclosure. While FIG. 2 depicts the RDC 21 of the turbine engine combustion section 20, the configuration of FIG. 2 is also applicable to the RDC 77 of the ramjet combustion section 76. Thus, in FIG. 2, elements that are applicable to the RDC 77 are depicted with parentheses, while elements not depicted in parentheses are applicable to both the RDC 21 and the RDC 77. In FIG. 2, the RDC 21 is arranged between the turbo-engine outer casing 25 and a combustor section inner casing 92 that, as shown in FIG. 1, surrounds the high-pressure shaft 34 and the low-pressure shaft 36. For clarity, both the high-pressure shaft 34 and the low-pressure shaft 36 are omitted from FIG. 2. The RDC 77 is arranged between the ramjet engine inner casing 72 and the ramjet engine outer casing 70. The RDC 21 and the RDC 77 extend about a combustor longitudinal centerline axis 16′, which corresponds to, and is congruent with, the longitudinal centerline axis 16 (FIG. 1) of the propulsion system 10. That is, the RDC 21 and the RDC 77 depicted in FIG. 2 are annular RDCs. However, the turbine engine combustion section 20 of FIG. 1 and the ramjet combustion section 76 are not limited to including an annular RDC, and, instead, the turbine engine combustion section 20 or the ramjet combustion section 76 may include a plurality of RDCs 21 (or a plurality of RDCs 77) that are circumferentially spaced apart about the combustor longitudinal centerline axis 16′ within the turbine engine combustion section 20 (or within the ramjet combustion section 76. The RDC 21 (and the RDC 77) defines an axial direction A extending parallel to the combustor centerline axis 16′, a radial direction R extending perpendicularly outward from the combustor centerline axis 16′, and a circumferential direction C extending about the combustor centerline axis 16′.

The RDC 21 includes a detonation chamber 94 defined by an outer wall 96, an inner wall 98, and an upstream wall 100. Each of the outer wall 96, the inner wall 98, and the upstream wall 100 is an annular wall that extends circumferentially about the combustor longitudinal centerline axis 16′ so as to define the detonation chamber 94. An inner surface 102 of the outer wall 96 is arranged at a radial distance 104 from the combustor longitudinal centerline axis 16′, and an outer surface 106 of the inner wall 98 is arranged at a radial distance 108 from the combustor longitudinal centerline axis 16′, thereby defining a radial height 110 of the detonation chamber 94. The RDC 21 includes an outlet 112 at a downstream end 114 of the detonation chamber 94. The detonation chamber 94 has a detonation chamber length 116 defined from the upstream wall 100 to the outlet 112. The outlet 112 is in fluid communication with the HPT 30 to provide the flow of the combustion gases 68 to the HPT 30. For the RDC 77, the outlet 112 is in fluid communication with the ramjet exhaust section 78.

The RDC 21 also includes an air source 118 (e.g., an air plenum) arranged upstream of the detonation chamber 94. The air source 118 extends annularly about the combustor longitudinal centerline axis 16′. An air inlet 120 is in fluid communication with the air source 118 and with the detonation chamber 94, and the air inlet 120 is arranged extending through the upstream wall 100. The air source 118 is in fluid communication with the HPC 28 (FIG. 1) to receive a flow of the compressed air 66 from the HPC 28, and the compressed air 66 flows from the air source 118 into the air inlet 120. For the RDC 77, the air source 118 is in fluid communication with the ramjet inlet section 74 to receive a flow of the compressed air 84. The air inlet 120 may extend annularly about the combustor longitudinal centerline axis 16′, may be arranged a radial distance 121 from the combustor longitudinal centerline axis 16′, and may have a radial height 122. Alternatively, a plurality of air inlets 120, which may constitute distinct openings (e.g., holes) through the upstream wall 100 with a hole diameter corresponding to the radial height 122 may be implemented instead.

The RDC 21 further includes a fuel plenum 124 that is in fluid communication with the fuel supply system 54 to receive either the fuel 56 or the fuel 88. While a plenum is described herein, a plenum need not be included and the fuel plenum 124 may instead constitute a manifold or any other type of fuel source for supplying fuel from the fuel supply system 54. The fuel plenum 124 may extend annularly about the combustor longitudinal centerline axis 16′, or may be a plurality of fuel plenums 124 that each extends partially annularly about the combustor longitudinal centerline axis 16′. The fuel plenum 124 includes a plurality of fuel injectors 126 (two shown in FIG. 2) that are arranged to inject the fuel 56 or to inject the fuel 88 into the air inlet 120. The plurality of fuel injectors 126 are arranged circumferentially spaced apart about the combustor longitudinal centerline axis 16′. The flow of the fuel 56 or the flow of the fuel 88 to the fuel plenum 124, and the flow of the fuel 56 or the fuel 88 from the fuel plenum 124 through the fuel injectors 126, are controlled by the engine controller 58 (FIG. 1). The fuel 56 or the fuel 88 injected via the plurality of fuel injectors 126 mixes within the air inlet 120 with the compressed air 66 (or with the compressed air 84) flowing through the air inlet 120 to form a fuel-air mixture 128 within the air inlet 120. The fuel-air mixture 128 is then injected from the air inlet 120 into the detonation chamber 94, where the fuel-air mixture 128 is then detonated by a spark from one or more ignitors 130 (or any other type of ignition device; one shown in FIG. 2) to generate rotating detonation waves (described in more detail below) within the detonation chamber 94. As will be described in more detail below, the discharge coefficient of the air inlet 120, in injecting the fuel-air mixture 128 into the detonation chamber 94, is controlled so as to control the operating mode (e.g., the number of the rotating detonation waves) of the RDC 21.

In the FIG. 2 aspect, the rotating detonation combustor 21 further includes a plurality of auxiliary gas injection ports 132 (two shown in FIG. 2) that are arranged to inject a stream of an auxiliary gas 134 into the air inlet 120 downstream of the fuel injectors 126. In FIG. 2, the plurality of auxiliary gas injection ports 132 are arranged to provide a flow of the auxiliary gas 134 in a radial inward direction into the air inlet 120. Alternatively, while not shown in FIG. 2, the auxiliary gas injection ports 132 may be arranged upstream of the fuel injectors 126. The auxiliary gas 134 mixes with the fuel-air mixture 128 within the air inlet 120 to generate a fuel-air-auxiliary gas mixture 129, which is then injected into the detonation chamber 94. The injection of the auxiliary gas 134 into the air inlet 120 alters the flow of the fuel-air mixture 128 within the air inlet 120 by, for example, inducing turbulence within the flow of the fuel-air mixture 128 through the air inlet 120, or by adding to the mass-flow of the fuel-air mixture 128 to generate the fuel-air-auxiliary gas mixture 129. As will be described below, the altering of the flow of the fuel-air mixture 128 within the air inlet 120 induces a change in the discharge coefficient of the air inlet 120.

The auxiliary gas 134 may be provided to the plurality of auxiliary gas injection ports 132 from an auxiliary gas source 136 via an auxiliary gas pump 145 and an auxiliary gas supply valve 146 that are controlled by the engine controller 58, an auxiliary gas supply line 138, and an auxiliary gas manifold 140 connected with the plurality of auxiliary gas injection ports 132. The auxiliary gas source 136 may be, for example, a compressor bleed air valve 142 that provides a flow of compressor bleed air as the auxiliary gas 134 from the compressor section 18 (FIG. 1). Alternatively, for the RDC 77, the auxiliary gas source 136 may be a stream of bleed air provided from the cooling air 65 (FIG. 1) flowing within the ramjet engine cooling passage 73 via bleed air inlets (now shown) that provide a flow of the cooling air 65 therethrough to the auxiliary gas injection port 132. Alternatively, the auxiliary gas source 136 may be a separate auxiliary gas tank 144 that stores the auxiliary gas 134. Here, the auxiliary gas 134 stored in the auxiliary gas tank 144 may be, for example, air, oxygen, nitrogen, or an oxygen and a nitrogen blend. Other sources for the auxiliary gas 134 may be implemented instead and the present disclosure is not limited to the foregoing auxiliary gas sources. The engine controller 58 controls the auxiliary gas supply valve 146 to provide the stream of the auxiliary gas 134 from the auxiliary gas tank 144. As will be described in more detail below, the stream of the auxiliary gas 134 provided to the air inlet 120 is controlled by the engine controller 58 to control the discharge coefficient of the air inlet 120 and to control the operating mode of the RDC 21.

The RDC 21 may also include one or more sensors 147 (one shown in FIG. 2) arranged upstream of the detonation chamber 94 (e.g., arranged in the air source 118). The one or more sensors 147 may be, for example, a temperature sensor that obtains temperature readings of the compressed air 66 within the air source 118, a pressure sensor that obtains pressure readings of the compressed air 66 within the air source 118, or that may measure pressure fluctuations within the air source 118, a flow meter sensor that obtains volumetric or velocity flow readings of the compressed air 66 within the air source 118, or an accelerometer that obtains vibration readings within the air source 118. Sensor data 148 is sent from the one or more sensors 147 to the engine controller 58.

The RDC 21 may also include a plurality of operating mode detection sensors 150 (one shown in FIG. 2) within the detonation chamber 94 near the upstream wall 100 of the detonation chamber 94. While the operating mode detection sensors 150 are shown as being located within the detonation chamber 94, additional operating mode detection sensors 150 may be arranged at other locations within the RDC 21, such as within the air source 118. The plurality of operating mode detection sensors 150 may be dynamic pressure measurement sensors that measure pressure fluctuations within the detonation chamber 94, and provide sensor data 152 (e.g., pressure fluctuation data) to the engine controller 58. The plurality of operating mode detection sensors 150 may constitute, for example, three operating mode detection sensors 150 that are non-uniformly spaced apart circumferentially about the combustor centerline axis 16′. The sensor data 152 (e.g., pressure fluctuation signals) provided to the engine controller 58 is utilized by the engine controller 58 to determine the operating mode of the RDC 21, and the engine controller 58 can then control the auxiliary gas source 136 accordingly to control the discharge coefficient of the air inlet 120 and to control the operating mode of the RDC 21.

Further, the RDC 21 may also include one or more sensors 154 (one shown in FIG. 2) arranged at the downstream end 114 of the RDC 21 (e.g., arranged adjacent to the outlet 112). The one or more sensors 154 may be, for example, a temperature sensor that obtains temperature readings of the combustion gases 68 within the detonation chamber 94, a pressure sensor that obtains pressure readings within the detonation chamber 94 adjacent to the outlet 112, a flow meter sensor that obtains volumetric or velocity flow readings of the combustion gases 68 to the outlet 112, or an accelerometer that obtains vibration readings of combustion dynamics vibrations within the detonation chamber 94. Sensor data 156 is sent from the one or more sensors 154 to the engine controller 58. Of course, additional sensors could be located at other locations within the turbine engine combustion section 20 to obtain additional sensor data that is provided to the engine controller 58. As will be described in more detail below, the engine controller 58 may utilize the sensor data 148 or the sensor data 156 to control the flow of the auxiliary gas 134 into the air inlet 120 to control the discharge coefficient of the air inlet 120 and to control operating mode (e.g., the number of the rotating detonation waves) within the detonation chamber 94.

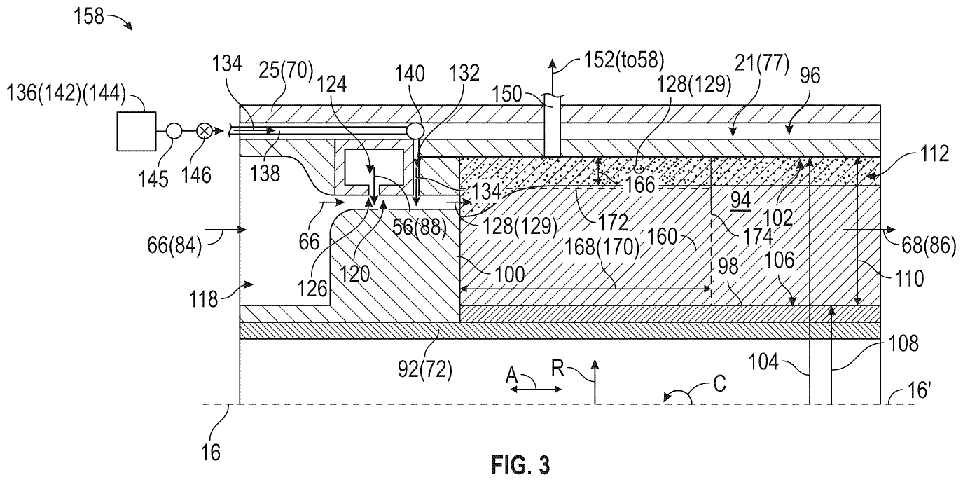

FIG. 3 is a cross-sectional view of a portion of the rotating detonation combustor 21 of FIG. 2, taken at detail view 158 in FIG. 2, according to an aspect of the present disclosure. With regard to FIG. 3, an operation of the RDC 21 (and, consequently, the RDC 77) will be described. As was described above, the compressed air 66 (or the compressed air 84) flows into the air source 118 (e.g., an air plenum) from the HPC 28 (FIG. 1) (or from the ramjet inlet section 74), and then flows into the air inlet 120. The fuel 56 (or the fuel 88) is injected into the air inlet 120 via the plurality of fuel injectors 126, where the fuel 56 (or the fuel 88) mixes with the compressed air 66 (or with the compressed air 84) within the air inlet 120 to generate reactants in the form of the fuel-air mixture 128. The fuel-air mixture 128 is injected from the air inlet 120 into the detonation chamber 94 (the flow of the fuel-air mixture 128 within the detonation chamber 94 is denoted by the shaded region along the outer wall 96), and the fuel-air mixture 128 is detonated by a spark from the ignitor 130 (FIG. 2) (or another ignition device) to generate rotating detonation waves 160 (shown generally by cross-hatching filling the radial height 110 of the detonation chamber 94). As will be described below, the rotating detonation waves 160 may not fill the entire radial height 110 of the detonation chamber 94, and instead, depending on the operating mode of the RDC 21, may only fill a portion of the radial height 110 of the detonation chamber 94 before a next successive rotating detonation wave 160 passes around the detonation chamber 94.

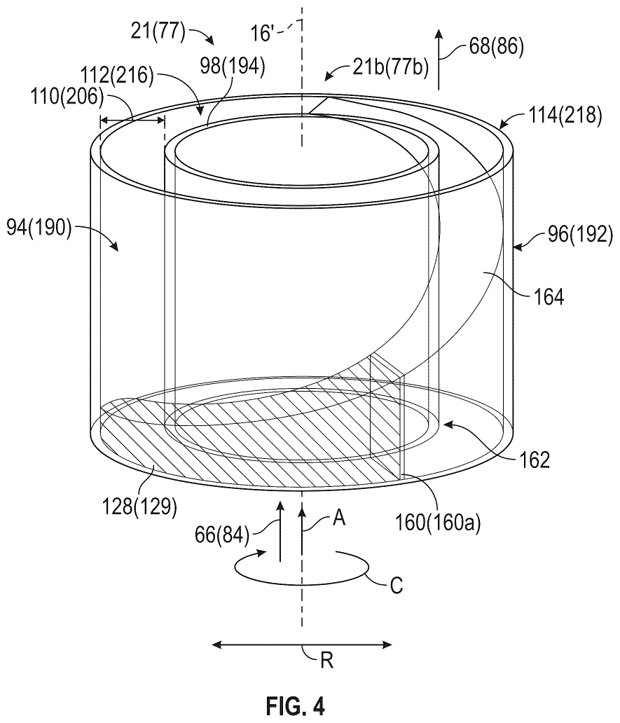

FIG. 4 is a schematic, perspective view of the detonation chamber 94 and a rotating detonation wave 160 within the detonation chamber 94. The rotating detonation wave 160 travels in a circumferential direction C and in an axial downstream direction A along the combustor centerline axis 16′ within the detonation chamber 94, consuming the fuel-air mixture 128, and providing a high-pressure region 162 within an expansion region 164 of the detonation chamber 94. The detonated fuel-air mixture 128 generates the rotating detonation wave 160, and combustion gases 68 from the rotating detonation wave 160 travel in the axial direction A and exit the detonation chamber 94 at the outlet 112. Thus, the detonation of the fuel-air mixture 128 produces a shock-induced flame, which results in the coupling of a reaction zone and a shockwave. The shockwave compresses and heats the fresh fuel-air mixture 128 that is injected into the detonation chamber 94, thereby increasing the fuel-air mixture 128 above a self-ignition point. On the other side of the shockwave, energy released by the combustion contributes to the propagation of the rotating detonation wave 160. With continuous detonation, the rotating detonation wave 160 propagates around the detonation chamber 94 in a continuous manner, operating at a relatively high frequency. Additionally, the rotating detonation wave 160 may be such that an average pressure inside the detonation chamber 94 is higher than an average pressure within typical combustion systems (i.e., deflagration combustion systems). Accordingly, the high-pressure region 162 behind the detonation wave 160 has a very high pressure.

While FIG. 4 depicts an example of a single rotating detonation wave 160 within the detonation chamber 94, more than one rotating detonation wave 160 may be present within the detonation chamber 94 at any one time during the operation of the rotating detonation combustor 21. For example, two rotating detonation waves 160 may be present within the detonation chamber 94 at the same time, and may have, for example, a one hundred eighty degree phase difference between them. As another example, three rotating detonation waves 160 may be present within the detonation chamber 94 at the same time, and may have, for example, a one hundred twenty degree phase difference between them. The number of rotating detonation waves 160 that may be present within the detonation chamber 94 at any given time is dependent upon several factors, including the flow of the compressed air 66 and the flow of the fuel 56 into the air inlet 120, and the discharge coefficient of the air inlet 120 into the detonation chamber 94 to backfill the detonation chamber 94 with the fuel-air mixture 128 behind a previous rotating detonation wave 160.

Referring back to FIG. 3, the fuel-air mixture 128 (or the fuel-air auxiliary gas mixture 129) flows from the air inlet 120 into the detonation chamber 94 and fills at least part of the radial height 110 of the detonation chamber 94 within an effective fill length 168. That is, as shown in FIG. 3, the fuel-air mixture 128 fills the detonation chamber 94 with a radial height 166 extending radially inward from the inner surface 102 of the outer wall 96 toward the inner wall 98, and with an effective fill length 168 from the upstream wall 100. The radial height 166 and the effective fill length 168 define an effective fill volume 172 of the fuel-air mixture 128 within the detonation chamber 94. By controlling the discharge coefficient of the air inlet 120, the effective fill volume 172 is also controlled so as control the detonation waves 160 and thus, to control the operating mode of the RDC 21.

One technique for controlling the discharge coefficient of the fuel-air mixture 128 from the air inlet 120 into the detonation chamber 94, and, therefore, to control the fuel-air mixture radial height 166 in the detonation chamber 94 and the resulting detonation wave 160, is to inject the auxiliary gas 134 into the air inlet 120 to mix with the fuel-air mixture 128. In addition to changing the mass flow rate of the fuel-air mixture 128 flowing through the air inlet 120 into the detonation chamber 94, the injection of the auxiliary gas 134 changes the boundary layer and turbulence properties of the flow of the fuel-air mixture 128 within the air inlet 120 such that the discharge coefficient, and, in turn, the amplitude of the detonation waves 160 or the number of detonation waves 160, can be controlled throughout the cycle of the engine. As was described above, the detonation waves 160 may fill the entire radial height 110 of the detonation chamber 94, or may fill a portion of the radial height 110 of the detonation chamber 94. For example, the detonation waves 160 may be about the same radial height 166 of the fuel-air mixture 128, may be less than the radial height 166 of the fuel-air mixture 128, or may be greater than the radial height 166 of the fuel-air mixture but less than the radial height 110 of the detonation chamber 94, depending on the operating mode of the RDC 21. The engine controller 58 may include, or refer to, a combustor cycle requirement table (or an auxiliary gas control table) 59 (FIG. 3), stored in the engine controller 58 and provide control signals to the auxiliary gas source 136 and to the auxiliary gas supply valve 146, to control the flow of the auxiliary gas 134 into the air inlet 120.

The engine controller 58 may also utilize the sensor data 148 from the sensor 147 or the sensor data 156 from the sensor 154 to control the flow of the auxiliary gas 134. For example, the combustor cycle requirement table 59 may also include projected sensor data (e.g., projected pressure data, projected operating mode data, projected temperature data, or projected vibration data) for each of the engine throttle power settings, and then may utilize the sensor data 148, the sensor data 152, or the sensor data 156 to control the flow of the auxiliary gas 134. Additionally, high speed pressure measurements acquired from multiple axial and circumferential locations by, for example, the operating mode detection sensors 150 are used to determine the operating mode of the system. If the operating mode changes to a non-ideal state during operation for a given cycle condition, the flow of the auxiliary gas 134 would be controlled to alter the injection conditions of the fuel-air mixture 128 into the detonation chamber 94 (i.e., to control the discharge coefficient of the air inlet 120) and, consequently, alter the operating mode of the RDC 21. Other techniques for determining the amount of the auxiliary gas adjustment could also be implemented, and the present disclosure is not limited to the foregoing.

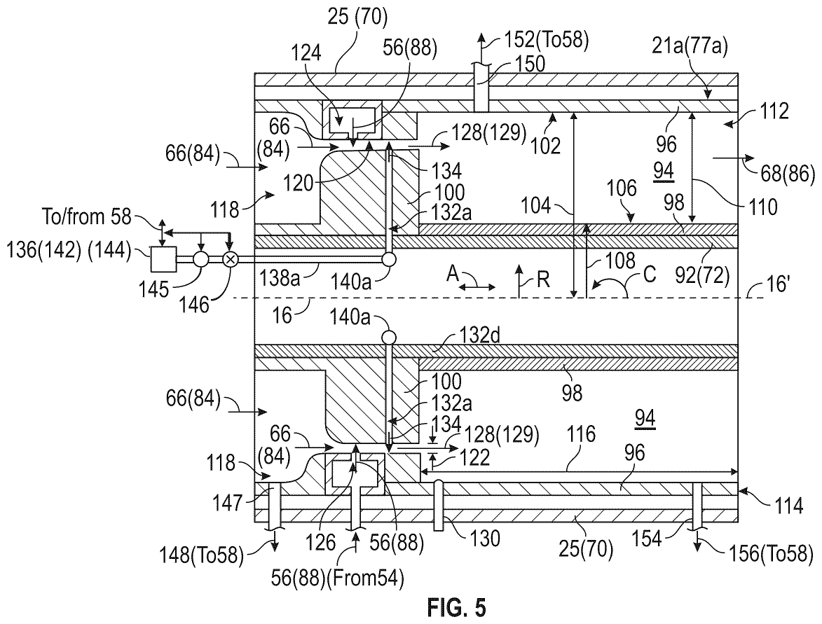

FIG. 5 is a cross-sectional view of an alternate RDC 21a (and alternate RDC 77a) to that shown in FIG. 2, according to an aspect of the present disclosure. Elements that are the same as those of the FIG. 2 aspect include the same reference numerals and the description of those elements provided above is equally applicable to the FIG. 5 aspect. One difference between the alternate RDC 21a (and the alternate RDC 77a) of the FIG. 5 aspect as compared with the FIG. 2 aspect is that, the alternate RDC 21a (and the alternate RDC 77a) includes a plurality of auxiliary gas injection ports 132a that are arranged to inject the auxiliary gas 134 radially outward into the air inlet 120 rather than injecting the auxiliary gas 134 radially inward as shown in FIG. 2. Thus, the FIG. 5 aspect includes an alternate auxiliary gas supply manifold 140a that is in fluid communication with the plurality of alternate auxiliary gas injection ports 132a, and an alternate auxiliary gas supply line 138a that is in fluid communication with the auxiliary gas supply manifold 140a and with the auxiliary gas source 136. The radially outward injection of the auxiliary gas 134 into the air inlet 120, however, provides the same effect on controlling the discharge coefficient of the air inlet 120 and the operating mode of the RDC 21a as the FIG. 2 aspect injecting the auxiliary gas 134 radially inward into the air inlet 120. Thus, the FIG. 5 aspect merely provides a different arrangement of the auxiliary gas injection ports 132a without otherwise changing the operation of the RDC 21a as described with regard to the FIG. 3 aspect for the RDC 21. The present disclosure is not limited to implementing either the auxiliary gas injection portion 132 or the auxiliary gas injection ports 132a, and an alternate arrangement in which both the auxiliary gas injection ports 132 and the auxiliary gas injection ports 132a are implemented together may also be provided.

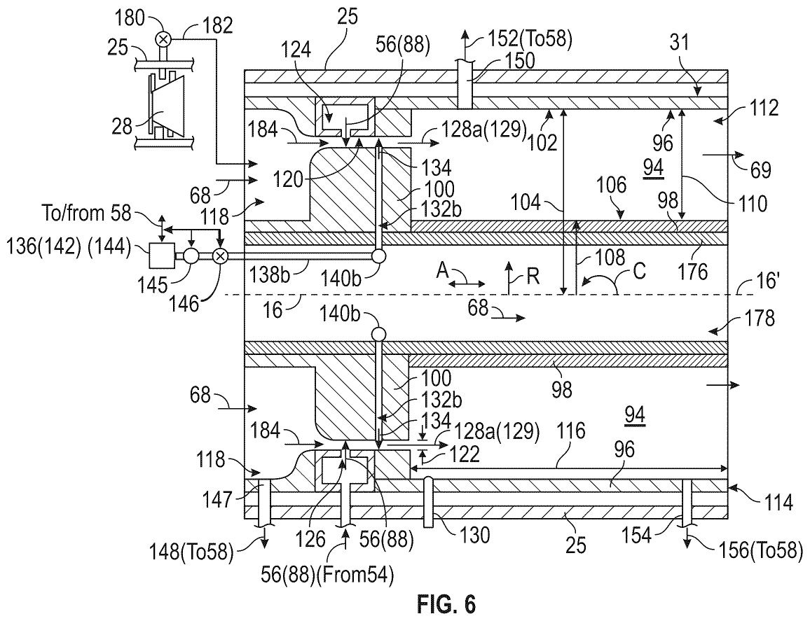

FIG. 6 is a cross-sectional view of the RDC 31 of the augmenter 27, according to an aspect of the present disclosure. The RDC 31 is similar to the RDC 21a of the FIG. 5 aspect, and, therefore, elements in FIG. 6 that are the same as those of the RDC 21a shown in the FIG. 5 aspect include the same reference numerals and the description of those elements provided above is equally applicable to the FIG. 6 aspect. In FIG. 6, the RDC 31 of the augmenter 27 is arranged between the turbo-engine outer casing 25 and an augmenter inner casing 176. The augmenter inner casing 176 defines a core exhaust flow path 178 through which the combustion gases 68 exiting the LPT 32 (FIG. 1) flow before entering the exhaust nozzle 29. In the RDC 31, the air source 118 is arranged downstream of the LPT 32 and a flow of a portion of the combustion gases 68 flows into the air source 118. In addition, the HPC 28 (shown schematically in FIG. 6) includes a compressor bleed air valve 180 arranged to receive a flow of the compressed air 66 flowing through the HPC 28, and the compressor bleed air valve 180 provides a flow of compressor bleed air 182 to the air source 118. Thus, the air source 118 can receive both a flow of the combustion gases 68 and the compressor bleed air 182 to mix in the air source 118 to form an air/exhaust mixture 184, and to provide the air/exhaust mixture to the air inlet 120. Then, in the same manner described above for the FIG. 2 aspect, the air/exhaust mixture 184 is mixed with the fuel 56 (or the fuel 88) injected into the air inlet 120 via the plurality of fuel injectors 126 to generate a fuel-air mixture 128a that is injected into the detonation chamber 94. In the same manner described above for FIG. 2 and FIG. 3, the fuel-air mixture 128 is detonated to generate the detonation waves 160.

Similar to the FIG. 5 aspect, the FIG. 6 aspect includes a plurality of auxiliary gas injection ports 132b that are in fluid communication with an auxiliary gas supply manifold 140b. The plurality of auxiliary gas injection ports 132b are arranged to provide the flow of the auxiliary gas 134 in the radially outward direction into the air inlet 120. The auxiliary gas supply manifold 140b is in fluid communication with an auxiliary gas supply line 138b that is in fluid communication with the auxiliary gas source 136. The auxiliary gas source 136 provides the flow of the auxiliary gas 134 to flow through the plurality of auxiliary gas injection ports 132b into the air inlet 120 to mix with the fuel-air mixture 128a prior to the fuel-air mixture 128a being injected into the detonation chamber 94. The control of the flow of the auxiliary gas 134 is performed in the same manner described above for the FIG. 2 aspect and the FIG. 3 aspect. Thus, the FIG. 6 aspect controls the discharge coefficient of the air inlet 120 and the operating mode of the RDC 31 in the same manner described above for the FIG. 2 aspect.

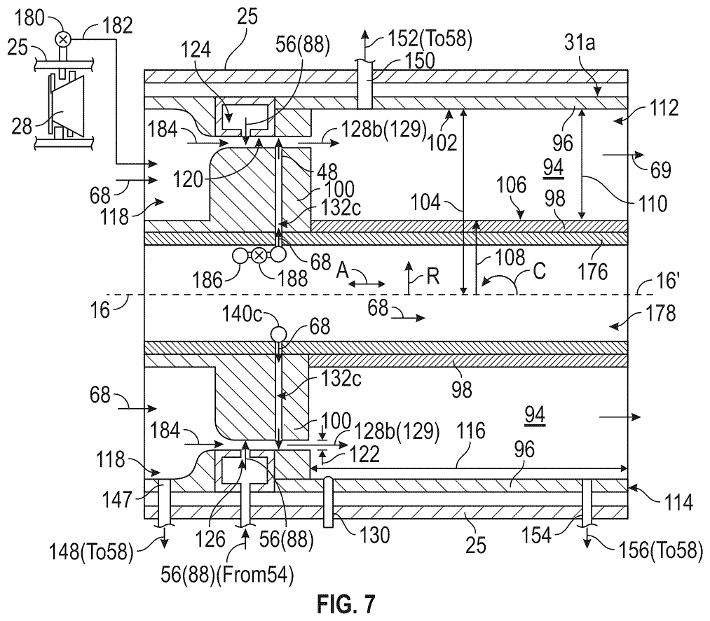

FIG. 7 is a cross-sectional view of an alternate RDC 31a of the augmenter 27 to that shown in FIG. 6, according to an aspect of the present disclosure. The RDC 31a is similar to the RDC 31 of the FIG. 6 aspect, and, therefore, elements in FIG. 7 that are the same as those of the RDC 31 shown in the FIG. 6 aspect include the same reference numerals and the description of those elements provided above is equally applicable to the FIG. 7 aspect. In FIG. 7, the RDC 31a includes an auxiliary gas supply manifold 140c that is in fluid communication with an plurality of auxiliary gas injection ports 132c. The auxiliary gas supply manifold 140c is in fluid communication an auxiliary gas control valve 188, that is in fluid communication with an auxiliary gas pump 186. The auxiliary gas pump 186 is in fluid communication with the core exhaust flow path 178, and both the auxiliary gas pump 186 and the auxiliary gas control valve 188 are controlled by the engine controller 58 (FIG. 1) to provide a flow of the combustion gases 68 therethrough from the core exhaust flow path 178 in a radially outward direction into the air inlet 120. Therefore, although the average pressure of the flow through the air inlet 120 may be greater than the pressure of the flow of the combustion gases 68 through the auxiliary gas injection port 132c, the inclusion of the auxiliary gas pump 186 provides the ability for the combustion gases 68 to be able to flow into the air inlet 120 to mix with the air/exhaust mixture 184 and the fuel 56 to generate a fuel-air mixture 128b that is injected into the detonation chamber 94. The remaining operations of the RDC 31a are the same as described above for the RDC 31.

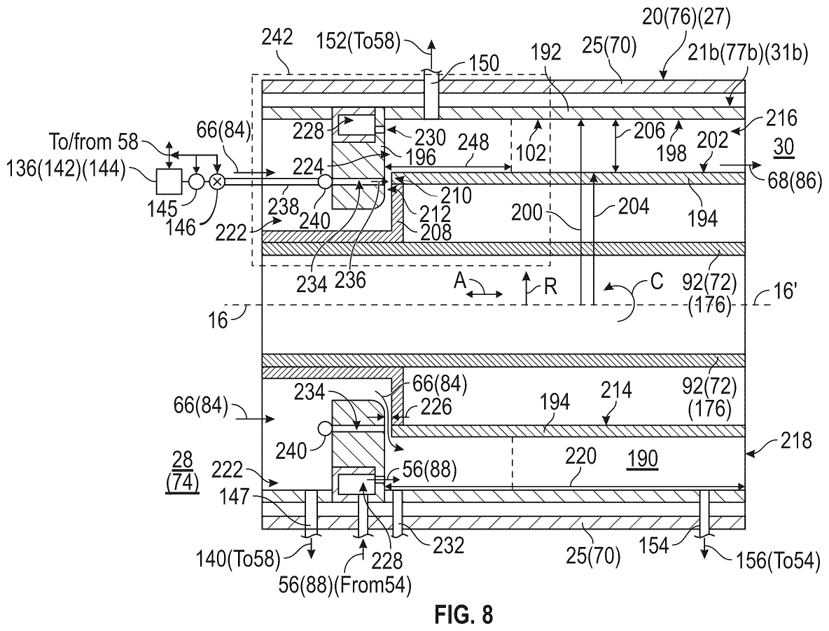

FIG. 8 is a cross-sectional view of an alternate rotating detonation combustor (RDC) 21b to that shown in FIG. 2, according to another aspect of the present disclosure. As will be described below, some main differences between the FIG. 8 aspect and the FIG. 2 aspect are that the FIG. 8 aspect provides a radial flow air inlet that provides a radially outward directed flow of air into the detonation chamber and that the mixing of the fuel and air is performed within the detonation chamber rather than being performed within the air inlet. In FIG. 8, the RDC 21b for the turbine engine combustion section 20 is shown, but the configuration of FIG. 8 is equally applicable as a rotating detonation combustor 77b of the ramjet combustion section 76 (FIG. 1). In addition, the FIG. 8 configuration is also applicable as a rotating detonation combustor 31b of the augmenter 27. Thus, in FIG. 8, reference numerals for elements that are specific to the RDC 77b or to the RDC 31b are shown in parentheses, while non-parenthetical reference numerals are applicable to each of the RDC 21b, the RDC 77b, and the RDC 31b.

In FIG. 8, the RDC 21b extends about the combustor longitudinal centerline axis 16′ and defines the axial direction A extending parallel to the combustor centerline axis 16′, the radial direction R extending perpendicularly outward from the combustor centerline axis 16′, and the circumferential direction C extending about the combustor centerline axis 16′. The RDC 21b is arranged between the combustor section inner casing 92 and the turbo-engine outer casing 25, while the RDC 77b of the ramjet combustion section 76 is arranged between the ramjet engine inner casing 72 and the ramjet engine outer casing 70.

The RDC 21b includes a detonation chamber 190 defined by an outer wall 192, an inner wall 194, and an upstream wall 196. Each of the outer wall 192, the inner wall 194, and the upstream wall 196 is an annular wall and extends circumferentially about the combustor longitudinal centerline axis 16′ so as to define the detonation chamber 190. An inner surface 198 of the outer wall 192 is arranged at a radial distance 200 from the combustor longitudinal centerline axis 16′, and an outer surface 202 of the inner wall 194 is arranged at a radial distance 204 from the combustor longitudinal centerline axis 16′, thereby defining a radial height 206 of the detonation chamber 190. The inner wall 194 also includes a radial wall 208 that extends radially inward from an upstream end 210 of the inner wall 194, and that extends circumferentially about the combustor centerline axis 16′. Together, the radial wall 208, the upstream end 210 of the inner wall 194, and the upstream wall 196 form an air inlet 212. The radial wall 208 and the inner wall 194 may be formed as a unitary wall that defines a centerbody 214 that extends circumferentially about the combustor longitudinal centerline axis 16′. The RDC 21b includes an outlet 216 at a downstream end 218 of the detonation chamber 190. The detonation chamber 190 has a detonation chamber length 220 defined from the upstream wall 196 to the outlet 216. The outlet 216 is in fluid communication with the HPT 30 (FIG. 1) to provide the flow of the combustion gases 68 to the HPT 30, or, for the RDC 77b, the outlet 216 is in fluid communication with the ramjet exhaust section 78 (FIG. 1) to provide the flow of the ramjet combustion gases 86 to the ramjet exhaust section 78.

The RDC 21b also includes an air source 222 (e.g., an air plenum) arranged upstream of the detonation chamber 190. The air inlet 212 is in fluid communication with the air source 222 and with the detonation chamber 190, and the air inlet 212 is arranged at an upstream end 224 of the of the detonation chamber 190. The air source 222 is in fluid communication with the HPC 28 (FIG. 1) of the turbine engine combustion section 20 to receive a flow of the compressed air 66 from the HPC 28, or, for the RDC 77b, the air source 222 is in fluid communication with the ramjet inlet section 74 of the ramjet combustion section 76 to receive a flow of the compressed air 84 from the ramjet inlet section 74. The compressed air 66 (or the compressed air 84) flows from the air source 222 through the air inlet 212 into the detonation chamber 190. The air inlet 212 may extend annularly about the combustor longitudinal centerline axis 16′ and may have an axial height 226. The air plenum 222 may also extend annularly about the combustor longitudinal centerline axis 16′.

The RDC 21b further includes a fuel plenum 228 that is in fluid communication with the fuel supply system 54 to receive either the fuel 56 or the fuel 88. The fuel plenum 228 may extend annularly about the combustor longitudinal centerline axis 16′, or may be a plurality of fuel plenums 228 that each extends partially annularly about the combustor longitudinal centerline axis 16′. In the FIG. 8 aspect, the upstream wall 196 defines, in part, the fuel plenum 228.

The RDC 21b further includes a plurality of fuel injectors 230 (two shown in FIG. 8) that are arranged to inject the fuel 56 or to inject the fuel 88 in an axial (i.e., longitudinal) direction into the detonation chamber 190. In the FIG. 8 aspect, the plurality of fuel injectors 230 extend through the upstream wall 196, and provide fluid communication between the fuel plenum 228 and the detonation chamber 190. The plurality of fuel injectors 230 are arranged circumferentially spaced apart about the combustor longitudinal centerline axis 16′. The flow of the fuel 56 or the flow of the fuel 88 to the fuel plenum 228, and the flow of the fuel 56 or the fuel 88 from the fuel plenum 228 through the at least one fuel injector 230, are controlled by the engine controller 58 (FIG. 1). As will be described in more detail below, the fuel 56 or the fuel 88 injected via the plurality of fuel injectors 230 mixes within the detonation chamber 190 with the compressed air 66 or with the compressed air 84 flowing through the air inlet 212 to form a fuel-air mixture within the detonation chamber 190 that is then detonated by a spark from one or more ignitors 232 (one shown in FIG. 8) (or another ignition device) to generate rotating detonation waves within the detonation chamber 190.

In the FIG. 8 aspect, the RDC 21b further includes a plurality of auxiliary gas injection ports 234 (two shown in FIG. 8) that are arranged to inject a stream of an auxiliary gas 236 in an axial direction into the air inlet 212, which is arranged in the radial direction. In FIG. 8, the plurality of auxiliary gas injection ports 234 are shown extending through the upstream wall 196. However, while not shown in FIG. 8, the auxiliary gas injection ports 234 may be arranged, for example, extending through the radial wall 208 instead. The auxiliary gas 134 may be provided to the plurality of auxiliary gas injection ports 234 from the auxiliary gas source 136 via the auxiliary gas pump 145 and the auxiliary gas supply valve 146 that are controlled by the engine controller 58, an auxiliary gas supply line 238, and an auxiliary gas manifold 240 connected with the plurality of auxiliary gas injection ports 234. The engine controller 58 controls the auxiliary gas pump 145 and the auxiliary gas supply valve 146 to provide the stream of the auxiliary gas 236 to the plurality of auxiliary gas injection ports 234. As will be described in more detail below, and in the same manner describe above for FIG. 2, the stream of the auxiliary gas 236 provided to the air inlet 212 is controlled by the engine controller 58 to control the discharge coefficient of the air inlet 212 for injecting the compressed air 66 (or the compressed air 84) into the detonation chamber 94 and to control the operating mode of the RDC 21b.

The RDC 21b may also include the one or more sensors 147 (one shown in FIG. 8) arranged upstream of the detonation chamber 190 (e.g., arranged in the air source 222). The one or more sensors 147 may be, for example, a temperature sensor that obtains temperature readings of the compressed air 66 within the air source 222, a pressure sensor that obtains pressure readings of the compressed air 66 within the air source 222, or that may measure pressure fluctuations within the air source 222, a flow meter sensor that obtains volumetric or velocity flow readings of the compressed air 66 within the air source 222, or an accelerometer that obtains vibration readings within the air source 222. The sensor data 148 is sent from the one or more sensors 147 to the engine controller 58.

The RDC 21b may also include the plurality of operating mode detection sensors 150 (one shown in FIG. 8) within the detonation chamber 190 near the upstream wall 196 of the detonation chamber 190. The plurality of operating mode detection sensors 150 may be dynamic pressure measurement sensors that measure pressure fluctuations within the detonation chamber 190, and provide the sensor data 152 (e.g., pressure fluctuation data) to the engine controller 58. The plurality of operating mode detection sensors 150 may constitute, for example, three operating mode detection sensors 150 that are non-uniformly spaced apart circumferentially about the combustor centerline axis 16′. The sensor data 152 (e.g., pressure fluctuation signals) provided to the engine controller 58 are utilized by the engine controller 58 to determine the operating mode of the RDC 21b, and the engine controller 58 can then control the auxiliary gas source 136 accordingly to control the operating mode of the RDC 21b.

Further, the RDC 21b may also include the one or more sensors 154 (one shown in FIG. 8) arranged at the downstream end 218 of the RDC 21b (e.g., arranged adjacent to the outlet 216). The one or more sensors 154 may be, for example, a temperature sensor that obtains temperature readings of the combustion gases 68 within the detonation chamber 190, a pressure sensor that obtains pressure readings within the detonation chamber 190 adjacent to the outlet 216, a flow meter sensor that obtains volumetric or velocity flow readings of the combustion gases 68 to the outlet 216, or an accelerometer that obtains vibration readings of combustion dynamics vibrations within the detonation chamber 190. The sensor data 156 is sent from the one or more sensors 154 to the engine controller 58. Of course, additional sensors could be located at other locations within the turbine engine combustion section 20 to obtain additional sensor data that is provided to the engine controller 58. As will be described in more detail below, the engine controller 58 may utilize the sensor data 148, the sensor data 152, or sensor data 156 to control the flow of the auxiliary gas 236 into the air inlet 212 to control the discharge coefficient of the air inlet 212, and to control the operating mode of the RDC 21b by controlling the number of the rotating detonation waves or the amplitude of the rotating detonation waves within the detonation chamber 190.

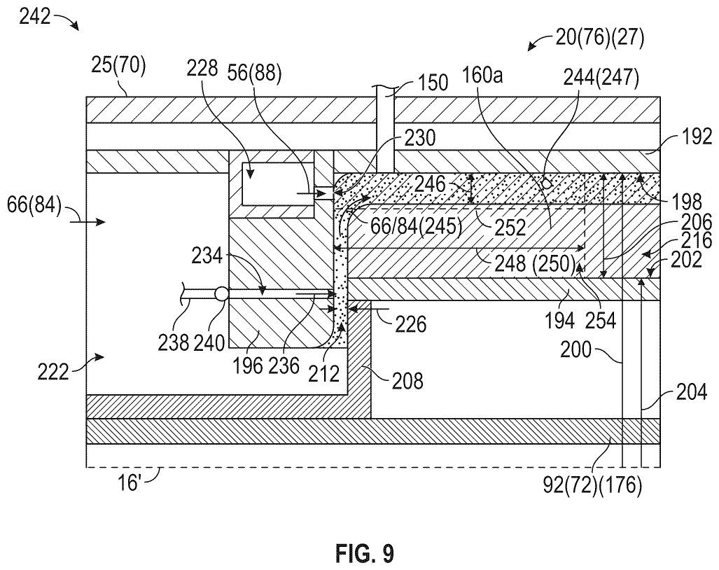

FIG. 9 is a cross-sectional view of a portion of the rotating detonation combustor 21b of FIG. 8, taken at detail view 242 in FIG. 8, according to an aspect of the present disclosure. With regard to FIG. 8, a description of an operation of the rotating detonation combustor 21b will be described. As was described above, the compressed air 66 flows into the air source 222 from the HPC 28, and then flows through the air inlet 212 into the detonation chamber 190 (the compressed air 66 flowing through the air inlet 212 being denoted by the dark shaded area). The fuel 56 is injected into the detonation chamber 190 via the plurality of fuel injectors 230, where the fuel 56 mixes with the compressed air 66 within the detonation chamber 190 to generate reactants in the form of a fuel-air mixture 244 (the fuel-air mixture 244 being denoted by the light shaded area). The fuel-air mixture 244 is detonated by a spark from an ignitor 232 (FIG. 8) (or by another ignition device) to generate rotating detonation waves 160a (shown generally by cross-hatching filling the radial height 206 of the detonation chamber 190). The fuel-air mixture 244 flows within the detonation chamber 190 with a radial height 246, which is an effective fill height for the fuel-air mixture 244 based on the discharge coefficient of the air inlet 212, over a given axial distance 248 that corresponds to an effective fill length 250. Thus, an effective fill volume 252 of the fuel-air mixture 244 is defined by the radial height 166 (the effective fill height) and the effective fill length 170. When the auxiliary gas 236 is injected into the auxiliary gas injection ports 234, the auxiliary gas 236 induces turbulence within the flow of the compressed air 66 through the air inlet 212 and changes the boundary layer of the flow of the compressed air 66 within the air inlet 212 to change the discharge coefficient of the air inlet 212. The auxiliary gas 236 also mixes with the flow of the compressed air 66 within the air inlet 212 to generate an air-auxiliary gas mixture 245 that is injected into the detonation chamber 190 to mix with the fuel 56 and to generate a fuel-air auxiliary gas mixture 247 within the detonation chamber 190 that is detonated to generate the rotating detonation waves 160a. The fuel-air mixture 244 fills (or back-fills after the passing of a detonation wave 160a) the detonation chamber 190. The rotating detonation waves 160a are generated in the same manner as described above with regard to FIG. 4 for the rotating detonation waves 160.

Upon detonation of the fuel-air mixture 244 or detonation of the fuel-air-auxiliary gas mixture 247 and the generation of the rotating detonation waves 160a, the rotating detonation waves 160a fill at least part of the radial height 206 of the detonation chamber 190. In the same manner described above for FIG. 3, the rotating detonation waves 160a may not fill the entire radial height 206 of the detonation chamber 190, and instead, depending on the operating mode of the RDC 21b, may only fill a portion of the radial height 206 of the detonation chamber 190 before a next successive rotating detonation wave 160a passes around the detonation chamber 190.

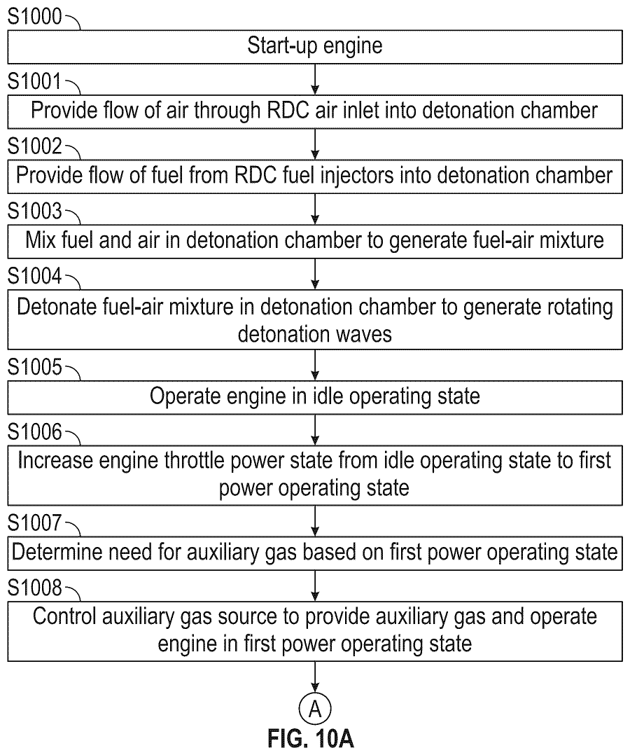

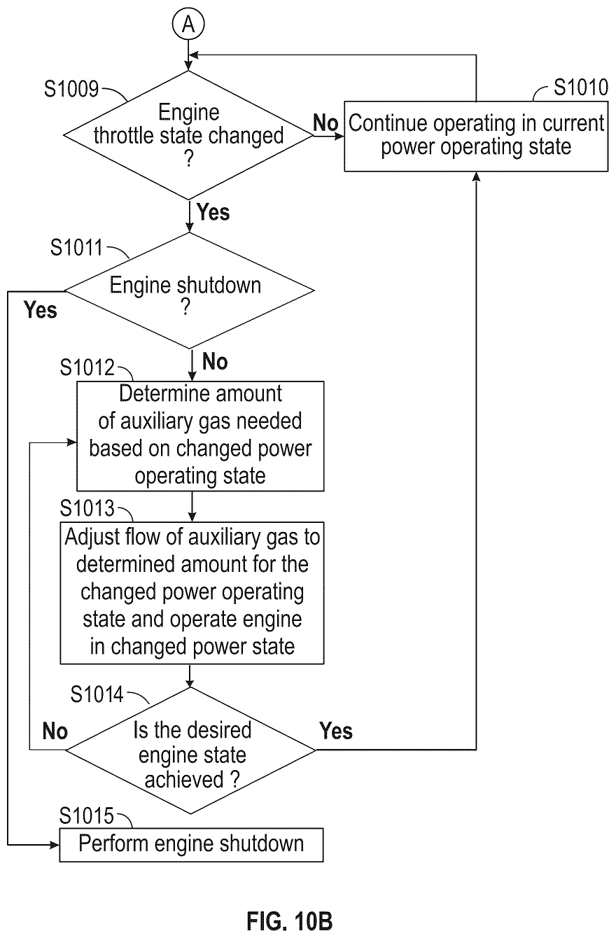

FIG. 10A and FIG. 10B depict a flowchart of process steps for a method of operating an engine having a rotating detonation combustor, according to an aspect of the present disclosure. The method may be implemented, for example, via the engine controller 58 storing in a memory (not shown) of the engine controller 58 computer-executable code of a program that is executed by a micro-processor (not shown) of the engine controller 58 for controlling operating of any of the rotating detonation combustors described above in FIG. 2 through FIG. 9 of the propulsion system 10. The method may be implemented in, for example, the turbo-engine 14 having the RDC 21 (or any of the other RDC's described above for the turbo-engine 14, including the RDC 31 of the augmenter 27), or may be implemented in the ramjet engine 12 having the RDC 77 (or any of the other RDC's described above for the ramjet engine 12). The following description, however, will be provided with regard to the method being implemented in the turbo-engine 14 and the RDC 21. In step S1000, the turbo-engine 14 is started-up, and, in step S1001, as the turbo-engine 14 starts-up, the compressor section 18 starts turning the LPC 26 and the HPC 28 to generate the flow of compressed air 66 that is provided to the turbine engine combustion section 20. As described above with regard to FIG. 2 and FIG. 3, the compressed air 66 flows into the air source 118 (e.g., an air plenum) and flows through the air inlet 120 into the detonation chamber 94. Continuing with the engine start-up, in step S1002, the flow of the fuel 56 is provided from the fuel plenum 124 through the fuel injectors 126 into the air inlet 120. In step S1003, the compressed air 66 and the fuel 56 mix in the air inlet 120 to generate the fuel-air mixture 128 that is injected into the detonation chamber 94 from the air inlet 120. In step S1004, the fuel-air mixture 128 is detonated by the ignitor 130 (FIG. 2) to generate the rotating detonation waves 160 (FIG. 3 and FIG. 4). Once the turbo-engine 14 has been started-up, the operation of the turbo-engine 14, and, in particular, the operation of the rotating detonation combustor 21 is controlled by the engine controller 58 from step S1005 through step S1014. In step S1005, the engine controller 58 controls the operation of the turbo-engine 14 to be operated in an idle power operating state.

Next, in step S1006, the turbo-engine 14 is operated to increase the engine throttle power state from the idle power operating state to a first power operating state (e.g., a low-power operating state) greater than the idle power operating state. For example, the engine throttle power state may be increased from the idle power operating state to a ten percent (10%) power operating state to commence taxiing of an aircraft upon which the turbo-engine 14 is connected. In step S1007, the engine controller 58, based on the increase in the engine throttle power operating state to the first power operating state, determines whether there is a need to provide the auxiliary gas 134 to the air inlet 120 based on the cycle requirements of the first power operating state. Here, the engine controller 58 may refer to an auxiliary gas control table (not shown) stored in the engine controller 58 to determine an amount of auxiliary gas 134 to be provided to the air inlet 120 via the plurality of auxiliary gas injection ports 132. The engine controller 58 may also utilize any of, or all of, the sensor data 148 (FIG. 2), the sensor data 156, or the sensor data 152 to determine, utilizing the auxiliary gas control table, the amount of the auxiliary gas 134 to inject into the air inlet 120, to control the discharge coefficient of the air inlet 120 and to control the operating mode of the RDC 21 as described above with regard to FIG. 3.

In step S1008, the engine controller 58 provides signals to the auxiliary gas source 136, to the auxiliary gas pump 145, and to the auxiliary gas supply valve 146 to control (e.g., to increase or to decrease) the flow of the auxiliary gas 134 to be provided to the plurality of auxiliary gas injection ports 132. The auxiliary gas source 136, the auxiliary gas pump 145, and the auxiliary gas supply valve 146 operate, based on the signals received from the engine controller 58, to control the flow of the auxiliary gas 134.

Referring to FIG. 10B, in step S1009, the engine controller 58 determines whether the engine throttle power operating state has changed. For example, the engine controller 58 may receive signals from an engine throttle control device (not shown) within the cockpit if the pilot changes (i.e., either increases or decreases) the engine throttle power state. In the foregoing description, the first power operating state (low-power operating state) was described as being ten percent (10%) for commencing taxiing of the aircraft. Here, in step S1009, the pilot may commence a take-off procedure by increasing the engine throttle for a second power operating state (i.e., a high-power operating state) to eighty percent (80%) or greater for rollout and take-off of the aircraft. In this case, the engine controller 58 receives signals from the engine throttle control device and the determination in step S1009 is YES. On the other hand, if the engine controller 58 determines that no change in the engine throttle power operating state has occurred (NO in step S1009), then, in step S1010, the turbo-engine 14 continues operating in the current power operating state (in this case, the turbo-engine 14 continues operating in the first power operating state).

When the determination in step S1009 is YES, then, in step S1011, the engine controller 58 may determine whether or not the change in the engine throttle power operating state is to shut down the turbo-engine 14. If so (YES in step S1011), then, in step S1015, the engine controller 58 initiates a shutdown operation of the turbo-engine 14. If not (NO in step S1011), then the engine controller 58 determines that another change in the engine throttle power operating state (i.e., an increase in the power or a decrease in the power) has occurred and, in step S1012, the engine controller 58 determines the amount of the auxiliary gas 134 to be provided to the air inlet 120. Here, the determination in step S1012 may be performed by the engine controller 58 in the same manner as in step S1007. For example, when the engine throttle power operating state has changed from the first power operating state (low-power operating state) of ten percent (10%) to the second power operating state (high-power operating state) of eighty percent (80%), the engine controller 58 refers to the auxiliary gas control table to determine the amount of the auxiliary gas 134 to be injected into the air inlet 120 for the eighty percent (80%) engine power.

In step S1013, the engine controller 58 provides signals to the auxiliary gas source 136, to the auxiliary gas pump 145, and to the auxiliary gas supply valve 146 to provide the determined amount of the auxiliary gas 134 to the air inlet 120, to adjust the discharge coefficient of the air inlet 120 and to control the operating mode of the RDC 21. In step S1014, a determination is made whether the desired engine operating state has been achieved. If not (NO in step S1014), then the flow returns to step S1012 and to step S1013 until the desired engine operating state has been achieved. Once the desired engine operating state has been achieved (YES in step S1014), then the process of FIG. 10B returns to step S1010 where the turbo-engine 14 continues to operate in the current (second) power operating state until a further change in the engine throttle power operating state is detected again, in step S1009. This loop in the process (from step S1009, step S1011, step S1012, step S1013, step S1014, and back to step S1010) continues through the full cycle (i.e., from start-up, taxiing, take-off, cruise, landing, taxiing to the gate) of the turbo-engine 14 until the shutdown of the turbo-engine 14 in step S1015.

The foregoing process of FIG. 10A and FIG. 10B provides the ability to change the discharge coefficient of the air inlet to control the inlet airflow to the detonation chamber 94 throughout the entire cycle of the operation of the turbo-engine 14 so that the discharge coefficient within the air inlet or the detonation chamber 94 can be controlled. By controlling the discharge coefficient, a more efficient burn of the fuel-air mixture can be achieved. In addition, the control of the inlet airflow to the detonation chamber 94 provides the ability to change the number of rotating detonation waves 160 within the detonation chamber 94 based on the cycle requirements, thereby controlling the operating mode of the RDC 21. For example, for higher power operating states, the inlet airflow can be increased so as to increase the number of rotating detonation waves 160 in order to better meet the higher power cycle requirements. Similarly, for lower power operating states, the number of rotating detonation waves 160 can be reduced by reducing the inlet airflow to the detonation chamber 94 to meet the lower power cycle requirements and to reduce fuel usage.

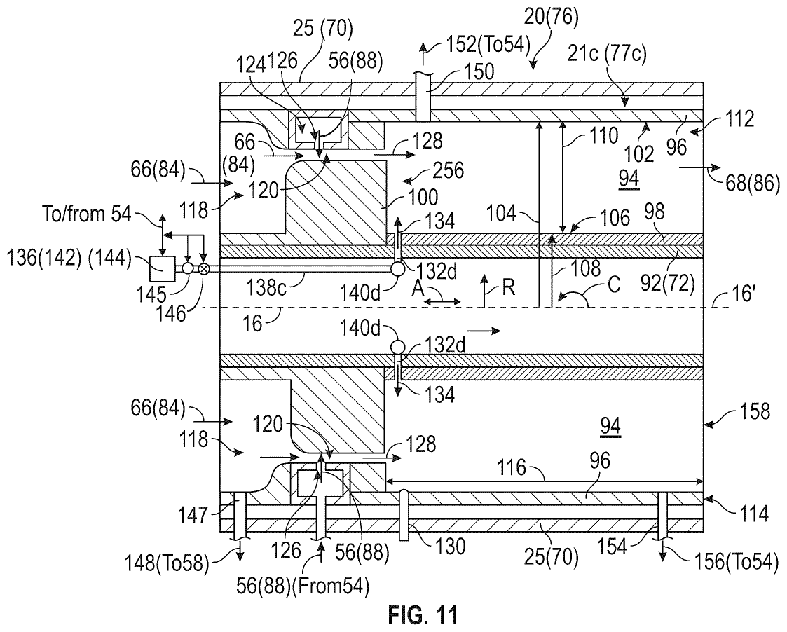

FIG. 11 is a cross-sectional view of an alternate rotating detonation combustor 21c (77c) to the rotating detonation combustor 21 of FIG. 2, according to an aspect of the present disclosure. In FIG. 11, elements that are the same as those of the FIG. 2 aspect include the same reference numerals, and the description of those elements provided above with regard to FIG. 2 is also applicable to the FIG. 11 aspect and, therefore, will not be repeated herein. In FIG. 11, rather than the auxiliary gas injection port 132 being arranged to provide the flow of the auxiliary gas 134 into the air inlet 120 as shown in FIG. 2, and to thereby change the discharge coefficient of the air inlet 120, a plurality of alternate auxiliary gas injection ports 132d (two shown in FIG. 11) are provided through the inner wall 98 of the RDC 21c to provide a flow of the auxiliary gas 134 into an upstream end 256 the detonation chamber 94. Similar to the FIG. 2 aspect, each of the plurality of auxiliary gas injection ports 132d is in fluid communication with an auxiliary gas supply manifold 140d that is in fluid communication with an auxiliary gas supply line 138c. In the same manner described above for the FIG. 2 aspect, the auxiliary gas source 136, the auxiliary gas pump 145, and the auxiliary gas supply valve 146 are controlled by the engine controller 58 to provide the flow of the auxiliary gas 134 to the plurality of auxiliary gas injection ports 132d.

While not shown in FIG. 11, the flow of the fuel-air mixture 128 into the detonation chamber 94 from the air inlet 120 in the FIG. 11 aspect may be the same as the flow of fuel-air mixture 128 into the detonation chamber 94 from the air inlet 120 as shown in the FIG. 3 aspect. Thus, as shown in FIG. 3, and as also applicable to FIG. 11, the fuel-air mixture 128 fills the detonation chamber 94 with the radial height 166 extending radially inward from the inner surface 102 of the outer wall 96 toward the inner wall 98, and with the effective fill length 168 from the upstream wall 100. The radial height 166 and the effective fill length 168 define the effective fill volume 172 of the fuel-air mixture 128 within the detonation chamber 94. In the FIG. 11 aspect, however, the auxiliary gas 134 is not injected into the air inlet 120 so as to control the discharge coefficient of the air inlet 120, but, instead the auxiliary gas 134 is injected into the upstream end 256 of the detonation chamber 94 via the auxiliary gas injection ports 132d. The injection of the auxiliary gas 134 into the detonation chamber 94 in this manner alters the radial height 166 of the flow of the fuel-air mixture 128 within the detonation chamber 94, which also alters the effective flow volume 172. As a result, the injection of the auxiliary gas 134 in into the detonation chamber 94 alters the discharge coefficient of the detonation chamber 94, which controls the operating mode of the RDC 21c in a similar manner to that of the FIG. 3 aspect.

Further aspects of the present disclosure are provided by the subject matter of the following clauses.

A method of operating a rotating detonation combustor, the rotating detonation combustor including (a) a detonation chamber defined by an outer wall, an inner wall, and an upstream wall, (b) an outlet at a downstream end of the detonation chamber, the detonation chamber having a detonation chamber length defined by a distance extending from the upstream wall to the outlet, (c) an air plenum arranged upstream of the detonation chamber, (d) an air inlet arranged in fluid communication with the air plenum and with the detonation chamber, (e) a fuel plenum, (f) at least one fuel injector arranged to inject fuel from the fuel plenum into one of the air inlet or the detonation chamber, and (g) an auxiliary gas injection port arranged to provide a flow of an auxiliary gas into the air inlet, the method comprises providing a flow of air from the air plenum through the air inlet to flow into the detonation chamber, providing a flow of fuel from the at least one fuel injector to mix with the flow of air from the air plenum in one of the air inlet or in the detonation chamber, mixing the flow of the fuel and the flow of the air in one of the air inlet or in the detonation chamber to generate a fuel-air mixture, detonating the fuel-air mixture in the detonation chamber to generate rotating detonation waves within the detonation chamber, and controlling, by an engine controller, during operation of the rotating detonation combustor from a first power operating state to a second power operating state, different from the first power operating state, a flow of the auxiliary gas through the auxiliary gas injection port into the air inlet to mix with the flow of the air within the air inlet to control a discharge coefficient of the air inlet and to control an operating mode of the rotating detonation combustor.

The method according to the preceding clause, (i) the air inlet being arranged to provide the flow of air and the flow of air mixed with the auxiliary gas into the detonation chamber, (ii) the fuel injector is arranged to provide the flow of the fuel into the detonation chamber apart from the flow of air provided by the air inlet, and (iii) the generating of the fuel-air mixture is performed in the detonation chamber.

The method according to any preceding clause, the first power operating state being a low-power operating state of the rotating detonation combustor, and the second power operating state is a high-power operating state of the rotating detonation combustor.

The method according to any preceding clause, the rotating detonation combustor being implemented as at least one of (i) a combustor in a compressor-fed combustion engine, (ii) an augmenter in the compressor-fed combustion engine, or (iii) a combustor in a ramjet engine.

The method according to any preceding clause, the controlling the flow of the auxiliary gas being executed by an engine controller utilizing at least one combustor cycle requirement table.

The method according to any preceding clause, the rotating detonation combustor being implemented in an augmenter of a compressor-fed combustion engine, and the air plenum is provided with at least one of a flow of compressor bleed air from a compressor of the compressor-fed combustion engine, or a flow of combustion gases from a turbine section of the compressor-fed combustion engine.

The method according to any preceding clause, the auxiliary gas being provided to the auxiliary gas injection port as one of a second flow of compressor bleed air from the compressor, or a flow of an auxiliary gas from an auxiliary gas tank.

The method according to any preceding clause, (i) the fuel injector being arranged to provide the flow of the fuel into the air inlet, (ii) the mixing of the flow of air and the flow of fuel to generate the fuel-air mixture is performed in the air inlet, (iii) the fuel-air mixture is provided from the air inlet into the detonation chamber, and (iv) the auxiliary gas injection port is arranged to inject the auxiliary gas within the air inlet to generate a fuel-air-auxiliary gas mixture that is injected from the air inlet into the detonation chamber.

The method according to any preceding clause, the air inlet extending axially through the upstream wall.

The method according to any preceding clause, (i) the air inlet being arranged to provide the flow of air radially into the detonation chamber, (ii) the fuel injector is arranged to provide the flow of the fuel into the detonation chamber apart from the flow of air provided by the air inlet, (iii) the mixing of the flow of air and the flow of fuel to generate the fuel-air mixture is performed in the detonation chamber, and (iii) the auxiliary gas injection port is arranged to inject the auxiliary gas into the flow of air within the air inlet.

The method according to any preceding clause, the at least one fuel injector being arranged through the upstream wall to inject the fuel from the fuel plenum into the detonation chamber, and the air inlet is arranged through the inner wall adjacent to the upstream wall and is arranged to provide the flow of the air radially into the detonation chamber.

The method according to any preceding clause, the rotating detonation combustor further including an auxiliary gas source that is in fluid communication with the auxiliary gas injection port to provide a flow of the auxiliary gas to the auxiliary gas injection port.

The method according to any preceding clause, the auxiliary gas being one of air, oxygen, or an oxygen and nitrogen blend gas.

The method according to any preceding clause, the rotating detonation combustor further including a plurality of operating mode detection sensors that provide pressure fluctuation data to the engine controller, and the engine controller controls the operating mode of the rotating detonation combustor by, at least in part, controlling the flow of auxiliary gas to be injected into the air inlet to control the discharge coefficient of the air inlet.

The method according to any preceding clause, the controlling the operating mode being based on at least one of a number of detonation waves, an orientation of the detonation waves, and a presence, an orientation, or a number of detrimental acoustic waves within the detonation chamber.

The method according to any preceding clause, the inner wall extending circumferentially about a combustor longitudinal centerline axis and extends longitudinally with respect to the combustor longitudinal centerline axis, and the outer wall extends circumferentially about the combustor longitudinal centerline axis and extends longitudinally with respect to the combustor longitudinal centerline axis, a radial distance between the inner wall and the outer wall defining a detonation chamber radial height.

The method according to any preceding clause, a portion of the detonation chamber extending downstream from the upstream wall to a given axial distance from the upstream wall defining a presumed fill length of the fuel-air mixture within the detonation chamber, and the fuel-air mixture fills a radial height within the detonation chamber extending radially inward from the outer wall, the presumed fill length and the radial height defining an effective flow volume of the fuel-air mixture, and the controlling the discharge coefficient of the air inlet controls the effective flow volume of the fuel-air mixture

The method according to any preceding clause, the controlling the discharge coefficient of the air inlet altering the radial height of the fuel-air mixture within the detonation chamber to control the effective flow volume of the fuel-air mixture.

A method of operating a rotating detonation combustor, the rotating detonation combustor including (a) a detonation chamber defined by an outer wall, an inner wall, and an upstream wall, (b) an outlet at a downstream end of the detonation chamber, the detonation chamber having a detonation chamber length defined by a distance extending from the upstream wall to the outlet, (c) an air plenum arranged upstream of the detonation chamber, (d) an air inlet arranged in fluid communication with the air plenum and with the detonation chamber, (e) a fuel plenum, (f) at least one fuel injector arranged to inject fuel from the fuel plenum into one of the air inlet or the detonation chamber, and (g) an auxiliary gas injection port arranged to provide a flow of an auxiliary gas into an upstream end of the detonation chamber, the method comprises providing a flow of air from the air plenum through the air inlet to flow into the detonation chamber, providing a flow of fuel from the at least one fuel injector to mix with the flow of air from the air plenum in one of the air inlet or in the detonation chamber, mixing the flow of the fuel and the flow of the air in one of the air inlet or in the detonation chamber to generate a fuel-air mixture, detonating the fuel-air mixture in the detonation chamber to generate rotating detonation waves within the detonation chamber, and controlling, by an engine controller, during operation of the rotating detonation combustor from a first power operating state to a second power operating state, different from the first power operating state, a flow of the auxiliary gas through the auxiliary gas injection port into the detonation chamber to control a discharge coefficient of the detonation chamber and to control an operating mode of the rotating detonation combustor.

The method according to any preceding clause, the auxiliary gas being one of air, oxygen, or an oxygen and nitrogen blend gas.

The method according to any preceding clause, wherein (i) the air inlet is arranged to provide the flow of air and the flow of air mixed with the auxiliary gas into the detonation chamber, (ii) the fuel injector is arranged to provide the flow of the fuel into the air inlet, and (iii) the generating of the fuel-air mixture is performed in the detonation chamber.

The method according to any preceding clause, the first power operating state being a low-power operating state of the rotating detonation combustor, and the second power operating state is a high-power operating state of the rotating detonation combustor.

The method according to any preceding clause, the rotating detonation combustor being implemented as at least one of (i) a turbine engine combustion section in a turbo-engine, (ii) an augmenter in the turbo-engine, or (iii) a ramjet combustion section in a ramjet engine.

The method according to any preceding clause, the controlling the flow of the auxiliary gas being executed by an engine controller utilizing at least one combustor cycle requirement table.

The method according to any preceding clause, the auxiliary gas being provided to the auxiliary gas injection port as one of a flow of compressor bleed air from the compressor section, or a flow of an auxiliary gas from an auxiliary gas tank.

The method according to any preceding clause, wherein (i) the fuel injector is arranged to provide the flow of the fuel into the air inlet, (ii) the mixing of the flow of air and the flow of fuel to generate the fuel-air mixture is performed in the air inlet, (iii) the fuel-air mixture is provided from the air inlet into the detonation chamber, and (iv) the auxiliary gas injection port is arranged to inject the auxiliary gas within the detonation chamber..

The method according to any preceding clause, the air inlet extending axially through the upstream wall.

The method according to any preceding clause, the rotating detonation combustor further including an auxiliary gas source that is in fluid communication with the auxiliary gas injection port to provide a flow of the auxiliary gas to the auxiliary gas injection port.

The method according to any preceding clause, the auxiliary gas being one of air, oxygen, nitrogen, or an oxygen and nitrogen blend gas.

The method according to any preceding clause, the rotating detonation combustor further including a plurality of operating mode detection sensors that provide pressure fluctuation data to the engine controller, and the engine controller controls the operating mode of the rotating detonation combustor by, at least in part, controlling the flow of auxiliary gas to be injected into the detonation chamber to control the discharge coefficient of the detonation chamber.

The method according to any preceding clause, the controlling the operating mode being based on at least one of a number of detonation waves, an orientation of the detonation waves, and a presence, an orientation, or a number of detrimental acoustic waves within the detonation chamber.

The method according to any preceding clause, the inner wall extending circumferentially about a combustor longitudinal centerline axis and extends longitudinally with respect to the combustor longitudinal centerline axis, and the outer wall extends circumferentially about the combustor longitudinal centerline axis and extends longitudinally with respect to the combustor longitudinal centerline axis, a radial distance between the inner wall and the outer wall defining a detonation chamber radial height.

The method according to any preceding clause, a portion of the detonation chamber extending downstream from the upstream wall to a given axial distance from the upstream wall defining a presumed fill length of the fuel-air mixture within the detonation chamber, and the fuel-air mixture fills a radial height within the detonation chamber extending radially inward from the outer wall, the presumed fill length and the radial height defining an effective flow volume of the fuel-air mixture, and the controlling the discharge coefficient of the detonation chamber controls the effective flow volume of the fuel-air mixture.

The method according to any preceding clause, the controlling the discharge coefficient of the detonation chamber altering the radial height of the fuel-air mixture within the detonation chamber to control the effective flow volume of the fuel-air mixture.

A rotating detonation combustor (RDC) including (a) a detonation chamber defined by an outer wall, an inner wall, and an upstream wall, (b) an outlet at a downstream end of the detonation chamber, the detonation chamber having a detonation chamber length defined by a distance extending from the upstream wall to the outlet, (c) an air plenum arranged upstream of the detonation chamber, (d) an air inlet arranged in fluid communication with the air plenum and with the detonation chamber, (e) a fuel plenum, (f) at least one fuel injector arranged to inject fuel from the fuel plenum into one of the air inlet, and (g) an auxiliary gas injection port arranged to provide a flow of an auxiliary gas into the air inlet, wherein the RDC is operated by providing a flow of air from the air plenum through the air inlet to flow into the detonation chamber, providing a flow of fuel from the at least one fuel injector to mix with the flow of air from the air plenum in one of the air inlet or in the detonation chamber, mixing the flow of the fuel and the flow of the air in one of the air inlet or in the detonation chamber to generate a fuel-air mixture, detonating the fuel-air mixture in the detonation chamber to generate rotating detonation waves within the detonation chamber, and controlling, by an engine controller, during operation of the rotating detonation combustor from a first power operating state to a second power operating state, different from the first power operating state, a flow of the auxiliary gas through the auxiliary gas injection port into the air inlet to mix with the flow of the air within the air inlet to control a discharge coefficient of the air inlet and to control an operating mode of the rotating detonation combustor.

The RDC according to the preceding clause, (i) the air inlet being arranged to provide the flow of air and the flow of air mixed with the auxiliary gas into the detonation chamber, (ii) the fuel injector is arranged to provide the flow of the fuel into the detonation chamber apart from the flow of air provided by the air inlet, and (iii) the generating of the fuel-air mixture is performed in the detonation chamber.

The RDC according to any preceding clause, the first power operating state being a low-power operating state of the rotating detonation combustor, and the second power operating state is a high-power operating state of the rotating detonation combustor.

The RDC according to any preceding clause, the rotating detonation combustor being implemented as at least one of (i) a combustor in a compressor-fed combustion engine, (ii) an augmenter in the compressor-fed combustion engine, or (iii) a combustor in a ramjet engine.

The RDC according to any preceding clause, the controlling the flow of the auxiliary gas being executed by an engine controller utilizing at least one combustor cycle requirement table.

The RDC according to any preceding clause, the rotating detonation combustor being implemented in an augmenter of a compressor-fed combustion engine, and the air plenum is provided with at least one of a flow of compressor bleed air from a compressor of the compressor-fed combustion engine, or a flow of combustion gases from a turbine section of the compressor-fed combustion engine.

The RDC according to any preceding clause, the auxiliary gas being provided to the auxiliary gas injection port as one of a second flow of compressor bleed air from the compressor, or a flow of an auxiliary gas from an auxiliary gas tank.

The RDC according to any preceding clause, (i) the fuel injector being arranged to provide the flow of the fuel into the air inlet, (ii) the mixing of the flow of air and the flow of fuel to generate the fuel-air mixture is performed in the air inlet, (iii) the fuel-air mixture is provided from the air inlet into the detonation chamber, and (iv) the auxiliary gas injection port is arranged to inject the auxiliary gas within the air inlet to generate a fuel-air-auxiliary gas mixture that is injected from the air inlet into the detonation chamber.

The RDC according to any preceding clause, the air inlet extending axially through the upstream wall.

The RDC according to any preceding clause, (i) the air inlet being arranged to provide the flow of air radially into the detonation chamber, (ii) the fuel injector is arranged to provide the flow of the fuel into the detonation chamber apart from the flow of air provided by the air inlet, (iii) the mixing of the flow of air and the flow of fuel to generate the fuel-air mixture is performed in the detonation chamber, and (iii) the auxiliary gas injection port is arranged to inject the auxiliary gas into the flow of air within the air inlet.

The RDC according to any preceding clause, the at least one fuel injector being arranged through the upstream wall to inject the fuel from the fuel plenum into the detonation chamber, and the air inlet is arranged through the inner wall adjacent to the upstream wall and is arranged to provide the flow of the air radially into the detonation chamber.

The RDC according to any preceding clause, the rotating detonation combustor further including an auxiliary gas source that is in fluid communication with the auxiliary gas injection port to provide a flow of the auxiliary gas to the auxiliary gas injection port.

The RDC according to any preceding clause, the auxiliary gas being one of air, oxygen, nitrogen, or an oxygen and nitrogen blend gas.

The RDC according to any preceding clause, the rotating detonation combustor further including a plurality of operating mode detection sensors that provide pressure fluctuation data to the engine controller, and the engine controller controls the operating mode of the rotating detonation combustor by, at least in part, controlling the flow of auxiliary gas to be injected into the air inlet to control the discharge coefficient of the air inlet.

The RDC according to any preceding clause, the controlling the operating mode being based on at least one of a number of detonation waves, an orientation of the detonation waves, and a presence, an orientation, or a number of detrimental acoustic waves within the detonation chamber.

The RDC according to any preceding clause, the inner wall extending circumferentially about a combustor longitudinal centerline axis and extends longitudinally with respect to the combustor longitudinal centerline axis, and the outer wall extends circumferentially about the combustor longitudinal centerline axis and extends longitudinally with respect to the combustor longitudinal centerline axis, a radial distance between the inner wall and the outer wall defining a detonation chamber radial height.

The RDC according to any preceding clause, a portion of the detonation chamber extending downstream from the upstream wall to a given axial distance from the upstream wall defining a presumed fill length of the fuel-air mixture within the detonation chamber, and the fuel-air mixture fills a radial height within the detonation chamber extending radially inward from the outer wall, the presumed fill length and the radial height defining an effective flow volume of the fuel-air mixture, and the controlling the discharge coefficient of the air inlet controls the effective flow volume of the fuel-air mixture.

The RDC according to any preceding clause, the controlling the discharge coefficient of the air inlet altering the radial height of the fuel-air mixture within the detonation chamber to control the effective flow volume of the fuel-air mixture.

A rotating detonation combustor (RDC) including (a) a detonation chamber defined by an outer wall, an inner wall, and an upstream wall, (b) an outlet at a downstream end of the detonation chamber, the detonation chamber having a detonation chamber length defined by a distance extending from the upstream wall to the outlet, (c) an air plenum arranged upstream of the detonation chamber, (d) an air inlet arranged in fluid communication with the air plenum and with the detonation chamber, (e) a fuel plenum, (f) at least one fuel injector arranged to inject fuel from the fuel plenum into one of the air inlet or the detonation chamber, and (g) an auxiliary gas injection port arranged to provide a flow of an auxiliary gas into an upstream end of the detonation chamber, the RDC being operated by providing a flow of air from the air plenum through the air inlet to flow into the detonation chamber, providing a flow of fuel from the at least one fuel injector to mix with the flow of air from the air plenum in one of the air inlet or in the detonation chamber, mixing the flow of the fuel and the flow of the air in one of the air inlet or in the detonation chamber to generate a fuel-air mixture, detonating the fuel-air mixture in the detonation chamber to generate rotating detonation waves within the detonation chamber, and controlling, by an engine controller, during operation of the rotating detonation combustor from a first power operating state to a second power operating state, different from the first power operating state, a flow of the auxiliary gas through the auxiliary gas injection port into the detonation chamber to control a discharge coefficient of the detonation chamber and to control an operating mode of the rotating detonation combustor.

The RDC according to any preceding clause, the auxiliary gas being one of air, oxygen, nitrogen, or an oxygen and nitrogen blend gas.

The RDC according to any preceding clause, (i) the air inlet being arranged to provide the flow of air and the flow of air mixed with the auxiliary gas into the detonation chamber, (ii) the fuel injector is arranged to provide the flow of the fuel into the air inlet, and (iii) the generating of the fuel-air mixture is performed in the detonation chamber.

The RDC according to any preceding clause, the first power operating state being a low-power operating state of the rotating detonation combustor, and the second power operating state is a high-power operating state of the rotating detonation combustor.

The RDC according to any preceding clause, the rotating detonation combustor being implemented as at least one of (i) a turbine engine combustion section in a turbo-engine, (ii) an augmenter in the turbo-engine, or (iii) a ramjet combustion section in a ramjet engine.

The RDC according to any preceding clause, the controlling the flow of the auxiliary gas being executed by an engine controller utilizing at least one combustor cycle requirement table.

The RDC according to any preceding clause, the auxiliary gas being provided to the auxiliary gas injection port as one of a flow of compressor bleed air from the compressor section, or a flow of an auxiliary gas from an auxiliary gas tank.

The RDC according to any preceding clause, (i) the fuel injector being arranged to provide the flow of the fuel into the air inlet, (ii) the mixing of the flow of air and the flow of fuel to generate the fuel-air mixture is performed in the air inlet, (iii) the fuel-air mixture is provided from the air inlet into the detonation chamber, and (iv) the auxiliary gas injection port is arranged to inject the auxiliary gas within the detonation chamber.

The RDC according to any preceding clause, the air inlet extending axially through the upstream wall.

The RDC according to any preceding clause, the rotating detonation combustor further including an auxiliary gas source that is in fluid communication with the auxiliary gas injection port to provide a flow of the auxiliary gas to the auxiliary gas injection port.

The RDC according to any preceding clause, the auxiliary gas being one of air, oxygen, or an oxygen and nitrogen blend gas.

The RDC according to any preceding clause, the rotating detonation combustor further including a plurality of operating mode detection sensors that provide pressure fluctuation data to the engine controller, and the engine controller controls the operating mode of the rotating detonation combustor by, at least in part, controlling the flow of auxiliary gas to be injected into the detonation chamber to control the discharge coefficient of the detonation chamber.

The RDC according to any preceding clause, the controlling the operating mode being based on at least one of a number of detonation waves, an orientation of the detonation waves, and a presence, an orientation, or a number of detrimental acoustic waves within the detonation chamber.

The RDC according to any preceding clause, the inner wall extending circumferentially about a combustor longitudinal centerline axis and extends longitudinally with respect to the combustor longitudinal centerline axis, and the outer wall extends circumferentially about the combustor longitudinal centerline axis and extends longitudinally with respect to the combustor longitudinal centerline axis, a radial distance between the inner wall and the outer wall defining a detonation chamber radial height.

The RDC according to any preceding clause, a portion of the detonation chamber extending downstream from the upstream wall to a given axial distance from the upstream wall defining a presumed fill length of the fuel-air mixture within the detonation chamber, and the fuel-air mixture fills a radial height within the detonation chamber extending radially inward from the outer wall, the presumed fill length and the radial height defining an effective flow volume of the fuel-air mixture, and the controlling the discharge coefficient of the detonation chamber controls the effective flow volume of the fuel-air mixture.

The RDC according to any preceding clause, the controlling the discharge coefficient of the detonation chamber altering the radial height of the fuel-air mixture within the detonation chamber to control the effective flow volume of the fuel-air mixture.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

We claim:

1. A method of operating a rotating detonation combustor, the rotating detonation combustor including (a) a detonation chamber defined by an outer wall, an inner wall, and an upstream wall, (b) an outlet at a downstream end of the detonation chamber, the detonation chamber having a detonation chamber length defined by a distance extending from the upstream wall to the outlet, (c) an air plenum arranged upstream of the detonation chamber, (d) an air inlet arranged in fluid communication with the air plenum and with the detonation chamber, (e) a fuel plenum, (f) at least one fuel injector arranged to inject fuel from the fuel plenum into one of the air inlet or the detonation chamber, and (g) an auxiliary gas injection port arranged to provide a flow of an auxiliary gas into one of the air inlet or into an upstream end of the detonation chamber, the method comprising:
providing a flow of air from the air plenum through the air inlet to flow into the detonation chamber;
providing a flow of fuel from the at least one fuel injector to mix with the flow of air from the air plenum in one of the air inlet or in the detonation chamber;
mixing the flow of the fuel and the flow of the air in one of the air inlet or in the detonation chamber to generate a fuel-air mixture;
detonating the fuel-air mixture in the detonation chamber to generate rotating detonation waves within the detonation chamber; and
controlling, by an engine controller, during operation of the rotating detonation combustor from a first power operating state to a second power operating state, different from the first power operating state, a flow of the auxiliary gas through the auxiliary gas injection port into one of the air inlet to mix with the flow of the air within the air inlet to control a discharge coefficient of the air inlet, or into the detonation chamber to mix with the fuel-air mixture within the detonation chamber to control a discharge coefficient of the detonation chamber, and to control an operating mode of the rotating detonation combustor.

2. The method according to claim 1, wherein (i) the air inlet is arranged to provide the flow of air and the flow of air mixed with the auxiliary gas into the detonation chamber, (ii) the fuel injector is arranged to provide the flow of the fuel into the detonation chamber apart from the flow of air provided by the air inlet, and (iii) the generating of the fuel-air mixture is performed in the detonation chamber.

3. The method according to claim 1, wherein the first power operating state is a low-power operating state of the rotating detonation combustor, and the second power operating state is a high-power operating state of the rotating detonation combustor.

4. The method according to claim 1, wherein the rotating detonation combustor is implemented as at least one of (i) a turbine engine combustion section in a turbo-engine, (ii) an augmenter in the turbo-engine, or (iii) a ramjet combustion section in a ramjet engine.

5. The method according to claim 1, wherein the controlling the flow of the auxiliary gas is executed by an engine controller utilizing at least one combustor cycle requirement table.

6. The method according to claim 1, wherein the rotating detonation combustor is implemented in an augmenter of a turbo-engine, and the air plenum is provided with at least one of a flow of compressor bleed air from a compressor section of the turbo-engine, or a flow of combustion gases from a turbine section of the turbo-engine.

7. The method according to claim 6, wherein the auxiliary gas is provided to the auxiliary gas injection port as one of a second flow of compressor bleed air from the compressor section, or a flow of an auxiliary gas from an auxiliary gas tank.

8. The method according to claim 1, wherein (i) the fuel injector is arranged to provide the flow of the fuel into the air inlet, (ii) the mixing of the flow of air and the flow of fuel to generate the fuel-air mixture is performed in the air inlet, (iii) the fuel-air mixture is provided from the air inlet into the detonation chamber, and (iv) the auxiliary gas injection port is arranged to inject the auxiliary gas within the air inlet to generate a fuel-air-auxiliary gas mixture that is injected from the air inlet into the detonation chamber.

9. The method according to claim 8, wherein the air inlet extends axially through the upstream wall.

10. The method according to claim 1, wherein (i) the air inlet is arranged to provide the flow of air radially into the detonation chamber, (ii) the fuel injector is arranged to provide the flow of the fuel into the detonation chamber apart from the flow of air provided by the air inlet, (iii) the mixing of the flow of air and the flow of fuel to generate the fuel-air mixture is performed in the detonation chamber, and (iii) the auxiliary gas injection port is arranged to inject the auxiliary gas into the flow of air within the air inlet.

11. The method according to claim 10, wherein the at least one fuel injector is arranged through the upstream wall to inject the fuel from the fuel plenum into the detonation chamber, and the air inlet is arranged through the inner wall adjacent to the upstream wall and is arranged to provide the flow of the air radially into the detonation chamber.

12. The method according to claim 1, wherein the rotating detonation combustor further includes an auxiliary gas source that is in fluid communication with the auxiliary gas injection port to provide a flow of the auxiliary gas to the auxiliary gas injection port.

13. The method according to claim 12, wherein the auxiliary gas is one of air, oxygen, nitrogen, or an oxygen and nitrogen blend gas.

14. The method according to claim 1, wherein the rotating detonation combustor further includes a plurality of operating mode detection sensors that provide pressure fluctuation data to the engine controller, and the engine controller controls the operating mode of the rotating detonation combustor by, at least in part, controlling the flow of auxiliary gas to be injected into the air inlet to control the discharge coefficient of the air inlet.

15. The method according to claim 14, wherein the controlling the operating mode is based on at least one of a number of detonation waves, an orientation of the detonation waves, and a presence, an orientation, or a number of detrimental acoustic waves within the detonation chamber.

16. The method according to claim 1, wherein the inner wall extends circumferentially about a combustor longitudinal centerline axis and extends longitudinally with respect to the combustor longitudinal centerline axis, and the outer wall extends circumferentially about the combustor longitudinal centerline axis and extends longitudinally with respect to the combustor longitudinal centerline axis, a radial distance between the inner wall and the outer wall defining a detonation chamber radial height.

17. The method according to claim 16, wherein a portion of the detonation chamber extending downstream from the upstream wall to a given axial distance from the upstream wall defines a presumed fill length of the fuel-air mixture within the detonation chamber, and the fuel-air mixture fills a radial height within the detonation chamber extending radially inward from the outer wall, the presumed fill length and the radial height defining an effective flow volume of the fuel-air mixture, and the controlling the discharge coefficient of the air inlet controls the effective flow volume of the fuel-air mixture.

18. The method according to claim 17, wherein the controlling the discharge coefficient of the air inlet alters the radial height of the fuel-air mixture within the detonation chamber to control the effective flow volume of the fuel-air mixture.

19. A rotating detonation combustor (RDC) comprising:
a detonation chamber defined by an outer wall, an inner wall, and an upstream wall;
an outlet at a downstream end of the detonation chamber, the detonation chamber having a detonation chamber length defined by a distance extending from the upstream wall to the outlet;
an air plenum arranged upstream of the detonation chamber;
an air inlet arranged in fluid communication with the air plenum and with the detonation chamber;
a fuel plenum;
at least one fuel injector arranged to inject fuel from the fuel plenum into one of the air inlet or into the detonation chamber; and
at least one auxiliary gas injection port arranged to provide a flow of an auxiliary gas into one of the air inlet or into the detonation chamber.

20. The RDC according to claim 19, wherein the RDC is operated by (a) providing a flow of air from the air plenum through the air inlet to flow into the detonation chamber, (b) providing a flow of fuel from the at least one fuel injector to mix with the flow of air from the air plenum in one of the air inlet or in the detonation chamber, (c) mixing the flow of the fuel and the flow of the air in one of the air inlet or in the detonation chamber to generate a fuel-air mixture, (d) detonating the fuel-air mixture in the detonation chamber to generate rotating detonation waves within the detonation chamber, and (e) controlling, by a controller, during operation of the rotating detonation combustor from a first power operating state to a second power operating state, different from the first power operating state, a flow of the auxiliary gas through the auxiliary gas injection port into one of the air inlet to mix with the flow of the air within the air inlet to control a discharge coefficient of the air inlet, or into an upstream end of the detonation chamber to mix with the fuel-air mixture within the detonation chamber to control a discharge coefficient of the detonation chamber, and to control an operating mode of the rotating detonation combustor.
